(19) United States
(12) Patent Application Publication
(10) Pub. No.: US 2025/0173954 A1
(43) Pub. Date: May 29, 2025

(54) THREE-DIMENSIONAL SCENE RECONSTRUCTION METHOD, APPARATUS, DEVICE AND STORAGE MEDIUM

(71) Applicant: Beijing Zitiao Network Technology Co., Ltd., Beijing (CN)

(72) Inventors: Lin MA, Beijing (CN); Bangbang YANG, Beijing (CN); Wenbo HU, Beijing (CN); Yuewen MA, Beijing (CN)

(21) Appl. No.: 18/963,836

(22) Filed: Nov. 29, 2024

(30) Foreign Application Priority Data
Nov. 28, 2023 (CN) 202311602928.2
Nov. 28, 2023 (CN) 202311605735.2

(51) Int. Cl. G06T 15/20; G06T 15/06; G06T 15/08

(52) U.S. Cl. CPC G06T 15/205; G06T 15/06; G06T 15/08; G06T 2200/24

(57) ABSTRACT

Embodiments of the present application provide three-dimensional scene reconstruction method, apparatus, device, and a storage medium. The method comprises the following steps: constructing a neural radiance field for a three-dimensional scene based on a multi-view image sequence in the three-dimensional scene; for each given point location center, determining ray sampling points at the point location center and color information of the ray sampling points based on the neural radiance field; performing multi-layer rendering on the color information of the ray sampling points to obtain a multi-sphere image reconstructed for the three-dimensional scene at the point location center.

### CROSS-REFERENCE TO RELATED APPLICATIONS

The present application is based on and claims priority to Chinese Application No. 202311605735.2, filed on Nov. 28, 2023 and Chinese Application No. 202311602928.2, filed on Nov. 28, 2023, the disclosure of the Chinese Application is hereby incorporated by reference in its entirety.

### TECHNICAL FIELD

Embodiments of the present application relate to the technical field of data processing, in particular to three-dimensional scene reconstruction method, apparatus, device, and storage medium.

### BACKGROUND

With rapid development of Extended Reality (XR) technology, a three-dimensional (3D) scene reconstruction technology can provide users with more and more virtual interactive scenes to enhance their immersive interactive experience in 3D scenes.

### SUMMARY

Embodiments of the present application provide three-dimensional scene reconstruction method, apparatus, device, and storage medium, which can realize accurate reconstruction of the three-dimensional scene at multiple point location ( [symbol] ) centers, and locally approximately represent a virtual scene after the reconstruction of the three-dimensional scene through a multi-sphere image at the multiple point location centers, thereby reducing calculation overhead of the three-dimensional scene reconstruction and ensuring comprehensive applicability of the three-dimensional scene reconstruction.

In a first aspect, an embodiment of the present application provides a three-dimensional scene reconstruction method, which comprises:
constructing a neural radiance field for a three-dimensional scene based on a multi-view image sequence in the three-dimensional scene;
for each given point location center, determining ray sampling points at the point location center and color information of the ray sampling points based on the neural radiance field;
performing multi-layer rendering on the color information of the ray sampling points to obtain a multi-sphere image reconstructed for the three-dimensional scene at the point location center.

In a second aspect, an embodiment of the present application provides a three-dimensional scene reconstruction apparatus, which comprises:
a neural radiance field construction module, configured to construct a neural radiance field for a three-dimensional scene based on a multi-view image sequence in the three-dimensional scene;
a point location color determination module, configured to, for each given point location center, determine ray sampling points at the point location center and color information of the ray sampling points based on the neural radiance field;
a three-dimensional scene reconstruction module, configured to perform multi-layer rendering on the color information of the ray sampling points to obtain a multi-sphere image reconstructed for the three-dimensional scene at the point location center.

In a third aspect, an embodiment of the present application provides an electronic device, which comprises:

a processor and a memory, wherein the memory is used for storing a computer program, and the processor is used for calling and executing the computer program stored in the memory to execute the three-dimensional scene reconstruction method provided in the first aspect of the present application.

In a fourth aspect, an embodiment of the present application provides a computer-readable storage medium for storing a computer program that causes a computer to execute the three-dimensional scene reconstruction method as provided in the first aspect of the present application.

In a fifth aspect, an embodiment of the present application provides a computer program product, including computer programs/instructions, which cause a computer to execute the three-dimensional scene reconstruction method provided in the first aspect of the present application.

### BRIEF DESCRIPTION OF DRAWINGS

In order to explain the technical solutions in the embodiments of the present application more clearly, the drawings needed in the description of the embodiments will be briefly introduced below. Obviously, the drawings in the following description are only some embodiments of the present application, and for those ordinary skilled in the field, other drawings can be obtained according to these drawings without paying creative work.

FIG. 1 is a flowchart of a three-dimensional scene reconstruction method provided by an embodiment of the present application;

FIG. 2 is an exemplary schematic diagram of a 3D scene reconstruction process provided by an embodiment of the present application;

FIG. 3 is a method flow chart of the multi-sphere image rendering process at each point location center provided by an embodiment of the present application;

FIG. 4 is an exemplary schematic diagram of the principle of setting the depth relationship between adjacent layers provided by an embodiment of the present application;

FIG. 5 is a method flow chart of an optimization process of the multi-sphere image reconstructed for the three-dimensional scene at any point location center provided by the embodiment of the present application;

FIG. 6 is an exemplary schematic chart of an optimization process of the multi-sphere image reconstructed for the three-dimensional scene at any point location center provided by the embodiment of the present application;

FIG. 7 is a schematic block diagram of a three-dimensional scene reconstruction apparatus provided by an embodiment of the present application;

FIG. 8 is a schematic block diagram of an electronic device provided by an embodiment of the present application;

FIG. 9 is a schematic diagram of an application scenario of an embodiment of the present application;

FIG. 10 is a schematic flowchart of a method for displaying a virtual scene provided by an embodiment of the present application;

FIG. 11 is a schematic flowchart of obtaining target virtual scene data provided by an embodiment of the present application;

FIG. 12 is a schematic diagram of a virtual scene obtained by three-dimensional reconstruction of a real scene as a house provided by an embodiment of the present application;

FIG. 13 is a schematic diagram of a first type of roaming point location including a central area and a boundary area provided by an embodiment of the present application;

FIG. 14 is a flowchart of another method for displaying a virtual scene provided by an embodiment of the present application;

FIG. 15 is a schematic diagram of a user moving from a first roaming point location C to a second roaming point location U provided by an embodiment of the present application;

FIG. 16 is a schematic block diagram of an apparatus for displaying a virtual scene provided by an embodiment of the present application.

### DETAILED DESCRIPTION OF EMBODIMENTS

In the following, the technical schemes in the embodiments of the present application will be clearly and completely described with reference to the drawings in the embodiments of the present application. Obviously, the described embodiments are only a part of, not all of, the embodiments of the present application. Based on the embodiments in the present application, all other embodiments obtained by those ordinary skilled in the art without paying creative work belong to the protection scope of the present application.

It should be noted that the terms “first” and “second” in the description and claims of the present application and the above drawings are used to distinguish similar objects, and are not necessarily used to describe a specific order or sequence. It should be understood that the data so used can be interchanged under appropriate circumstances, so that the embodiments of the present application described herein can be implemented in other orders than those illustrated or described herein. Furthermore, the terms “including” and “having” and any variations thereof are intended to cover non-exclusive inclusion, for example, a process, method, system, product or server that includes a series of steps or units is not necessarily limited to those explicitly listed, but may include other steps or units not explicitly listed or inherent to these processes, methods, products or devices.

In the embodiments of the present application, the words “exemplary” or “for example” are used as examples, illustrations or explanations, and any embodiment or scheme described as “exemplary” or “for example” in the embodiments of the present application should not be interpreted as being more preferred or advantageous than other embodiments or schemes. To be exact, the usage of words such as “exemplary” or “for example” aims to present related concepts in a concrete way.

In the description of embodiments of the present application, unless otherwise specified, “a plurality of” refers to two or more, that is, at least two. “At least two” means two or more. “At least one” means one or more.

In order to facilitate understanding of embodiments of the present application, before describing various embodiments of the present application, some concepts involved in all embodiments of the present application will be first explained appropriately, as follows:

XR refers to creating a virtual environment in which human-computer interaction can be performed, by combining reality and virtuality through computers. XR is also a general term for various technologies such as Virtual Reality (VR), Augmented Reality (AR) and Mixed Reality (MR). Through the integration of such three visual interaction technologies, it brings “immersivity” of seamless transition between the virtual world and the real world to the experiencer. XR devices are usually worn on the user's head, so XR devices are also called head-mounted equipment.

VR: a technology of creating and experiencing a virtual world, which generates a virtual environment by calculation. It is a kind of multi-source information (the virtual reality mentioned herein includes at least visual perception, in addition, it can also include auditory perception, tactile perception, motion perception, and even taste perception, smell perception, etc.), so as to realize simulation of integrated and interactive three-dimensional dynamic vision and entity behavior of the virtual environment, so that users can immerse themselves in the simulated virtual reality environment, so as to implement appliance in a variety of virtual environments such as maps, games, videos, education, medical care, simulation, collaborative training, sales, assistance in manufacturing, maintenance and repair, or the like.

VR device refers to a terminal that realizes the virtual reality effect, and it can usually be provided in the form of glasses, Head Mount Display (HMD), and contact lenses, to realize visual perception and other forms of perception. Of course, the form of virtual reality device is not so limited, and it can be further miniaturized or enlarged as needed.

AR: AR scenery refers to a simulated scenery in which at least one virtual object is superimposed on a physical scenery or its representation. For example, an electronic system may have an opaque display, and at least one imaging sensor for capturing images or videos of the physical scenery, which are representations of the physical scenery. The system combines the images or videos with a virtual object and displays the combination on the opaque display. The individual uses the system to indirectly view the physical scenery via the images or videos of the physical scenery, and observes the virtual object superimposed on the physical scenery. When the system uses one or more image sensors to capture images of a physical scenery and uses those images to present an AR scenery on an opaque display, the displayed images are called video transparent transmission. Alternatively, the electronic system for displaying the AR scenery may have a transparent display or translucent display, through which an individual can directly view the physical scenery. The system can display virtual objects on a transparent display or translucent display, so that individuals can use the system to observe the virtual objects superimposed on the physical scenery. As another example, the system may include a projection system that projects a virtual object into a physical scenery. A virtual object can be projected, for example, on a physical surface or as a hologram, so that an individual uses the system to observe a virtual object superimposed on a physical scenery. Specifically, it is a technology that in the process of acquiring images by a camera, the camera attitude information parameters of the camera in the real world (or the three-dimensional world or the true world) can be calculated in real time, and virtual elements are added to the images acquired by the camera according to the camera attitude information parameters. Virtual elements include, but not limited to, images, videos and 3D models. The goal of AR technology is to connect the virtual world with the real world for interaction on the screen.

MR: By presenting the virtual scene information in the real scene, an interactive feedback information loop is set up between the real world, the virtual world and the user, so as to enhance the authenticity of the user experience. For example, computer-created sensory input (for example, a virtual object) is integrated with sensory input from a physical scenery or its representation in a simulated scenery, and in some MR sceneries, the computer-created sensory input can adapt to the change of sensory input from the physical scenery. In addition, some electronic systems for presenting MR sceneries can monitor information about orientation and/or position relative to the physical scenery, so as to enable virtual objects to interact with real objects, i.e., physical elements from the physical sceneries or their representations. For example, the system can monitor the movement so that a virtual plant appears stationary relative to a physical building.

Optionally, the XR devices described in the embodiments of the present application, also called virtual reality devices, may include but not limited to the following types:

1) Mobile virtual reality equipment, which supports setting up mobile terminals (such as smart phones) in various ways (such as a head-mounted display provided with a special card slot). By means of wired or wireless connection with the mobile terminals, the mobile terminals can perform relevant calculation of virtual reality functionalities and output data to the mobile virtual reality equipment, for example, watching virtual reality videos through the mobile terminal's APP.

2) All-in-one virtual reality equipment, which is provided with a processor for performing relevant calculation of virtual functionalities, so that it has independent functionalities of virtual reality input and output, without needing to be connected with a PC or a mobile terminal, so it has high freedom of usage.

3) Computer-side virtual reality (PCVR) equipment, which uses the PC side to perform relevant calculation and data output of virtual reality functionalities, and external computer-side virtual reality equipment uses data output from PC side to achieve virtual reality effect.

Virtual scene (also called virtual space) is a virtual scene that is displayed (or provided) when an application runs on an electronic device. The virtual scene can be a simulation environment for the real world, a semi-simulated and semi-fictional virtual scene, and a purely fictional virtual scene. The virtual scene can be any one of a two-dimensional virtual scene, a 2.5-dimensional virtual scene or a three-dimensional virtual scene, and the dimensions of the virtual scene are not limited in embodiments of the present application. For example, the virtual scene can include sky, land, ocean, etc., and the land can include environmental elements such as deserts and cities.

Virtual objects, which can interact with each other in the virtual scene, can be controlled by users or robot programs (for example, robot programs based on artificial intelligence) and can be static, move and perform various behaviors in the virtual scene.

3 degree of freedom (3Dof) refers to having three degrees of freedom of rotation, that is, having the ability to rotate on the X, Y and Z axes, but not having the ability to move on the X, Y and Z axes.

6 degree of freedom (6 DOF) refers to three degrees of freedom of rotation and three position-related degrees of freedom in up-down, front-back and right-left, that is, having the ability to rotate on the X, Y and Z axes, as well as the ability to move on the X, Y and Z axes.

Hereinafter the schemes related to three-dimensional scene reconstruction according to the present application will be described in detail.

In order to enhance users' diverse interactions in 3D scenes, it is usually possible to reconstruct a virtual scene that is completely consistent with the 3D scene, so as to support users to perform various interactive operations in the virtual scene and improve users' immersive interactive experience in the 3D scene.

Specific application scenarios of the virtual scene reconstructed for the three-dimensional scene in the present application can include a variety of scenes. For example, the virtual scene reconstructed for any three-dimensional scene in the present application can be presented in mobile phones, tablet computers, personal computers, servers and smart wearable devices, so that users can view the reconstructed virtual scene of the three-dimensional scene. When the reconstructed virtual scene of the three-dimensional scene is presented on the XR device, users can enter the reconstructed virtual scene of the three-dimensional scene by wearing the XR device, so as to perform various interactive operations to realize diverse interactions of users in the three-dimensional scene.

In general, as a kind of radiance field that represents a three-dimensional scene as an approximation by a neural network, a neural radiance field (NeRF) has more advantages than a traditional Multi-View Stereo (MVS) reconstruction method in terms of authenticity and reduction degree of rendering of the three-dimensional scene.

However, when using NeRF to directly render 3D scenes, there will be too much amount of rendering calculation, which leads to high requirement of device processing performance, and makes it difficult to support real-time rendering of 3D scenes on middle and low end XR devices, and there are certain limitations for 3D scene reconstruction.

In order to solve the above problems, the inventive concept of the present application is: firstly, a multi-view image sequence in a three-dimensional scene may be processed to construct a neural radiance field for a three-dimensional scene. Then, for each given point location center, ray sampling points at the point location center and color information of each ray sampling point may be determined based on the neural radiance field, and multi-layer rendering is performed on the color information of the ray sampling point to obtain a multi-sphere image reconstructed for the three-dimensional scene at the point location center, thus realizing accurate reconstruction of the three-dimensional scene at the multiple point location centers. The virtual scene after three-dimensional scene reconstruction can be approximately represented locally by the multi-sphere images at the multiple point location centers, which ensures true stereoscopic impression after three-dimensional scene reconstruction, reduces computational overhead of three-dimensional scene reconstruction, and can also achieve accurate reconstruction of three-dimensional scene on middle and low end XR devices, thus ensuring the comprehensive applicability of three-dimensional scene reconstruction.

Hereinafter, a 3D scene reconstruction method provided by an embodiment of the present application will be described in detail with reference to the attached drawings.

FIG. 1 is a flowchart of a three-dimensional scene reconstruction method provided by an embodiment of the present application. The method can be executed by a three-dimensional scene reconstruction apparatus provided by the present application, wherein the three-dimensional scene reconstruction apparatus can be realized by any software and/or hardware. For example, the three-dimensional scene reconstruction apparatus can be configured in any electronic device such as XR device, server, mobile phone, tablet computer, personal computer, smart wearable device, etc. The present application does not impose any restrictions on the specific types of electronic devices.

Specifically, as shown in FIG. 1, the method may include the following steps:

S110, constructing a neural radiance field for a three-dimensional scene based on a multi-view image sequence in the three-dimensional scene.

Among them, the three-dimensional scene can be any real environment where the user is located.

In order to realize accurate reconstruction of 3D scene, firstly, it is necessary to obtain 3D shapes and texture information of various kinds of real objects in 3D scene, such as actual objects, walls, ground and so on in the 3D scene, all-round. For this reason, a camera can be set at any position in a 3D scene, and multiple real environment images of the 3D scene can be shot by the camera from multiple views, thus forming a multi-view image sequence in the present application.

It can be understood that in order to realize the comprehensive reconstruction of the three-dimensional scene, the multi-view image sequence in the present application can form a panoramic image of the three-dimensional scene after being arranged according to the corresponding shooting angles, so that the geometric structure and appearance information of the three-dimensional scene can be comprehensively understood in the future.

Because there may be weak texture areas in each image in the multi-view image sequence, it is difficult for the traditional MVS reconstruction method to represent subtle and complex geometric structures in the three-dimensional scene, and it is also difficult for the image texture in the multi-view image sequence to reproduce detailed information in the three-dimensional scene such as illumination and materials with high fidelity. As a kind of radiance field that represents a three-dimensional scene as an approximation by a neural network, NeRF can accurately describe color information and bulk density of each spatial point in the 3D scene in each observation direction, and have more advantages than a traditional Multi-View Stereo (MVS) reconstruction method in terms of reduction degree of geometric structure and rendering authenticity.

Therefore, in the present application, when reconstructing any three-dimensional scene, firstly, multiple cameras can be set at different positions in the three-dimensional scene, or the position of a single camera can be changed, and the orientation of camera at each position can be set, so as to capture real scene images in the three-dimensional scene from multiple different positions and views, thus forming a multi-view image sequence in the present application.

Then, the network structure of NeRF in the present application is a simple fully connected network.

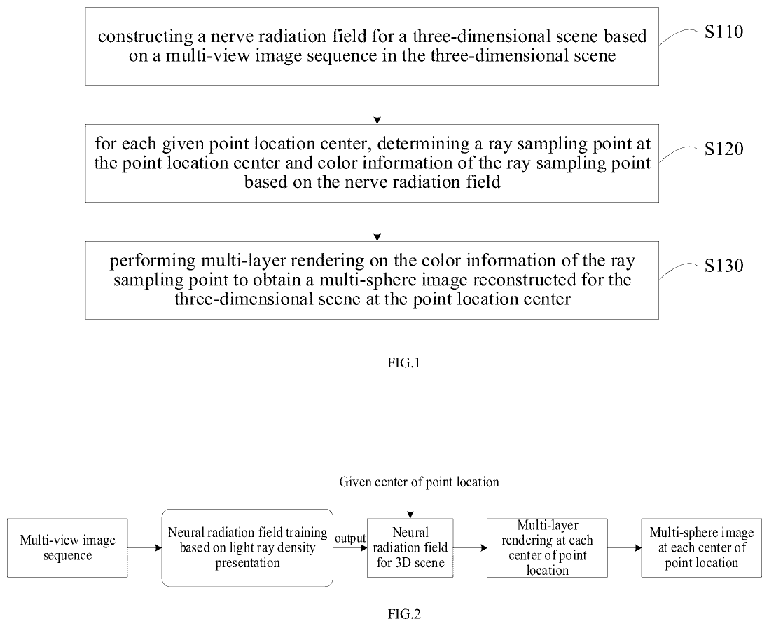

As shown in FIG. 2, for a multi-view image sequence, by processing geometric structure information and texture features in the real scene images in the multi-view image sequence captured from each view correspondingly, the neural radiance field for the three-dimensional scene can be trained, so as to construct the neural radiance field for the three-dimensional scene.

Specifically, for each view image in the multi-view image sequence, by analyzing the camera position and camera orientation corresponding to the view image, a corresponding radiation ray can be formed facing each pixel in an imaging plane of the camera starting from the camera position, so that a plurality of radiation rays under the multi-view image sequence can be obtained. For each radiation ray, a corresponding ray sampling strategy can be adopted, and a plurality of ray sampling points can be continuously sampled on that radiation ray. Then, by processing the texture features in each real scene image in the multi-view image sequence correspondingly, the color information and bulk density of each ray sampling point on each radiation ray can be predicted, thus constructing the neural radiance field for the three-dimensional scene.

Among them, the neural radiance field for the three-dimensional scene can include particle information, such as color, bulk density, illumination intensity, material and so on, of each ray sampling point on each radiation ray in the three-dimensional scene, so as to represent the actual texture of each real object in the three-dimensional scene.

In some optional implementation, in order to ensure the high-fidelity appearance information of the three-dimensional scene, the present application can express the neural radiance field based on the light ray density, and analyze the particle information, such as color, bulk density, illumination intensity, material and so on, of each ray sampling point in the three-dimensional scene, so as to generate the neural radiance field for the three-dimensional scene to express the high-fidelity appearance information of the three-dimensional scene.

S120, for each given point location center, determining a ray sampling point at the point location center and color information of the ray sampling point based on the neural radiance field.

In order to ensure convenient interaction of users in the three-dimensional scene, the present application can preset a plurality of default position points in the three-dimensional scene, and after presenting a virtual scene after the three-dimensional scene reconstruction to users, can also support users to select a plurality of custom position points in the presented virtual scene. Then, whether it is a default position point or a custom position point, the position point can be taken as the center point, and according to a preset range size, a plurality of corresponding user-roamable areas can be delineated respectively, and in turn, the user-roamable areas can be taken as a plurality of point locations in the three-dimensional scene in the present application. Then, the centers of the point locations are multiple point location centers that have been given in the 3D scene.

Then, after having constructed the neural radiance field for the three-dimensional scene, for each given point location center, the present application can process the specific position of the point location center and each supported camera attitude information correspondingly, so that according to the neural radiance field for the three-dimensional scene, multiple radiation rays that are formed facing the pixels in an imaging plane of the camera starting from the camera position at the point location center can be determined. For each radiation ray, a corresponding ray sampling strategy can be adopted, and a plurality of ray sampling points are continuously sampled on that radiation ray, so as to obtain each ray sampling point at the point location center. Moreover, according to high-fidelity appearance information represented by the neural radiance field for the three-dimensional scene, the color information of each ray sampling point can be determined, which can include the color information (that is, RGB value) and bulk density information of the ray sampling point.

In some optional implementations, for accuracy of the color information of the ray sampling points at each point location center, the present application can determine the ray sampling points and the color information of the ray sampling points at each point location center through the following steps:

Step 1, for each given point location center, determining the radiation rays and the ray sampling points on the radiation rays at the point location center according to the neural radiance field.

For each point location center, according to the camera view angles that the point location center can support in the neural radiance field, it can be determined that a plurality of radiation rays are formed outward from the point location center according to the neural radiance field. For each radiation ray, a corresponding ray sampling strategy can be adopted to continuously sample the radiation ray, for example, sampling at intervals of preset length on the radiation ray, so as to obtain ray sampling points on each radiation ray as the ray sampling points at the point location center.

Step 2, according to the neural radiance field, determining the color information of the ray sampling points.

Because the neural radiance field for the three-dimensional scene can include particle information, such as color, bulk density, illumination intensity, material and so on, of each ray sampling point on each radiation ray in the three-dimensional scene, so as to represent the actual texture of each real object in the three-dimensional scene, after having determined each ray sampling point at each point location center, the present application can determine the color information of each ray sampling point at the point location center, which includes RGB color values and bulk density information of the ray sampling point, according to the high-fidelity appearance information represented by the neural radiance site for the three-dimensional scene.

S130, performing multi-layer rendering on the color information of the ray sampling point to obtain a multi-sphere image reconstructed for the three-dimensional scene at the point location center.

Since through volume rendering in the neural radiance field, it is possible to analyze the color intensity projected by ray sampling points on multiple radiation rays on the imaging plane to render the projected image on the imaging plane, in order to ensure true stereoscopic impression of the three-dimensional scene reconstruction, the present application can set, for each point location center, a corresponding image layer at each of a plurality of different depths of the point location center respectively, so that multiple layers can be set around each point location center.

Then, for each point location center, by comparing the depth of each layer at the point location center with the size of depth interval between ray sampling points, the volume rendering method designed in the neural radiance field can be used to determine the color intensity projected by the color information of a part of ray sampling points that can affect each layer on the layer, to obtain the rendered image on the layer. In the same way as mentioned above, the color information of each ray sampling point at the point location center can be projected onto each layer to render each layer at the point location center, so as to obtain the rendered image on each layer at the point location center, thus forming a Multi-Sphere Image (abbreviated as MSI) reconstructed for the three-dimensional scene at the point location center.

Among them, MSI can be a kind of data format that extends Multi-Plane Images (abbreviated as MPI) to 360 spherical surfaces. At each point location center in the 3D scene, a multi-sphere image is presented around, which enhances the real stereoscopic impression of the reconstructed 3D scene.

It can be understood that the volume rendering formula designed in the neural radiance field in the present application can be:

$${\sum }_{n = 1}^{N} T ( {t}_{1} \to {t}_{n} ) * ( 1 - exp ( - {σ}_{n} ( {t}_{n + 1} - {t}_{n} ) ) ) * {c}_{n}$$

Where, n is the serial number of each ray sampling point belonging to the same radiation light at each point location when the ray sampling points are arranged from near to far. tₙ indicates the distance between the n-th ray sampling point and the point location. σₙ can be the bulk density of the n-th ray sampling point, and Cₙ can be the RGB color value of the n-th ray sampling point.

Then, the opacity of the n-th ray sampling point can be expressed by (1−exp(−σₙ(tₙ₊₁−tₙ))).

T(t₁→tₙ) can be the transmittance from the first ray sampling point to the n-th ray sampling point when the ray sampling points on the same radiation light at the point location center are arranged from near to far.

Where

$$T ( {t}_{1} \to {t}_{n} ) = exp ( {\sum }_{k = 1}^{n - 1} - {σ}_{k} {δ}_{k} ) ,$$

δₖ represents the distance between adjacent ray sampling points, that is, tₖ₊₁−tₖ.

Therefore, according to the above formula, for each point location center, the color information of a part of ray sampling points at the point location center that can affect each layer can be projected on the layer, and the color intensity after projection on the layer can be calculated, to obtain the rendered image on each layer at the point location center, so as to form a multi-sphere image reconstructed for the three-dimensional scene at the point location center.

In addition, for any three-dimensional scene, the multi-sphere image reconstructed at each point location center can support the user's panoramic roaming function in the three-dimensional scene to display the corresponding roaming image for the user in real time. Therefore, after obtaining the multi-sphere image reconstructed for the three-dimensional scene at each point location center, the present application can also obtain information about roaming pose of the user, which includes the roaming position and roaming posture; if the roaming position is within the point location, a corresponding roaming image is displayed according to the roaming pose information and the multi-sphere image reconstructed at the point location center.

That is to say, for a user roaming in the three-dimensional scene, the present application can obtain the roaming pose information of the user in real time, so as to determine the roaming position and the roaming posture of the user in the three-dimensional scene in real time.

Each point location can be composed of the point location center and the user-roamable area. By judging the roaming position of the user and the boundary of the roamable area of each point location, it can be determined that the roaming position is located in a certain point location.

When the user's roaming position is within a certain point location, the present application can first obtain the multi-sphere image reconstructed at the point location center. Then, by processing the roaming pose information of the user, the roaming view angle range in the multi-sphere image reconstructed by the user at the point location center can be determined, so as to render a local multi-sphere image of the multi-sphere image at the point location center that is within the roaming view angle range, thereby displaying the corresponding roaming image.

According to the technical scheme provided by the embodiment of the present application, firstly, a multi-view image sequence in a three-dimensional scene may be processed to construct a neural radiance field for a three-dimensional scene. Then, for each given point location center, ray sampling points at the point location center and color information of each ray sampling point may be determined based on the neural radiance field, and multi-layer rendering is performed on the color information of the ray sampling point to obtain a multi-sphere image reconstructed for the three-dimensional scene at the point location center, thus realizing accurate reconstruction of the three-dimensional scene at the multiple point location centers. The virtual scene after three-dimensional scene reconstruction can be approximately represented locally by the multi-sphere images at the multiple point location centers, which ensures true stereoscopic impression after three-dimensional scene reconstruction, reduces computational overhead of three-dimensional scene reconstruction, and can also achieve accurate reconstruction of three-dimensional scene on middle and low end XR devices, thus ensuring the comprehensive applicability of three-dimensional scene reconstruction.

As an optional implementation in the present application, because at each point location center of the three-dimensional scene, the depths of the real object are different when viewing the three-dimensional scene from different camera view angles, so that the depths of multiple layers set at each point location center are also different, thus generating multi-sphere images at different depths. Therefore, in order to ensure true accuracy of the reconstructed 3D scene, the present application can explain a specific rendering process of the multi-sphere image reconstructed for the 3D scene at each point location center.

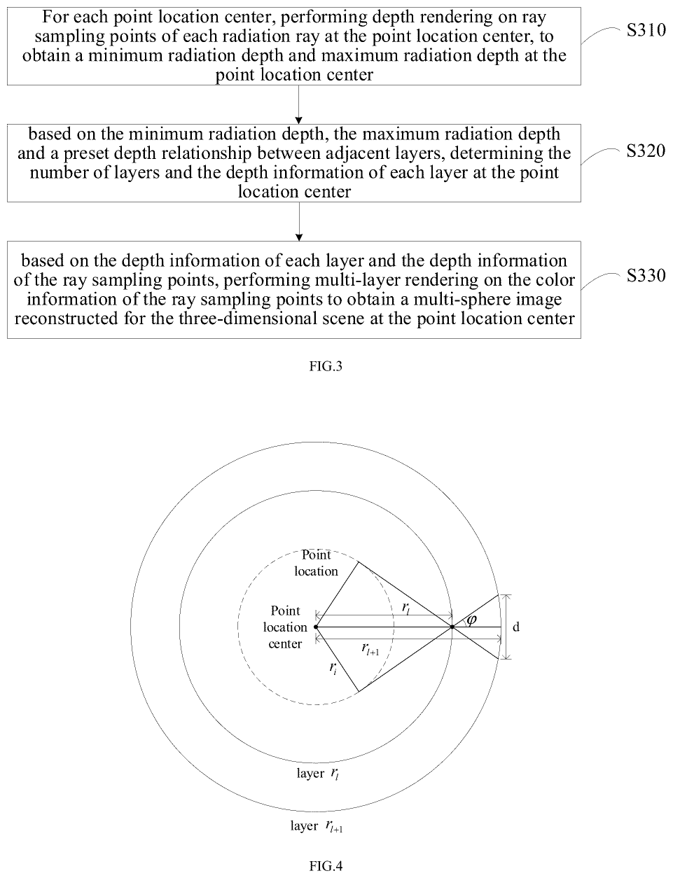

FIG. 3 is a method flow chart of the image rendering process of the multi-layer spherical shell at each point location center provided by the embodiment of the present application. As shown in FIG. 3, the method can specifically include the following steps:

S310: For each point location center, performing depth rendering on ray sampling points of each radiation ray at the point location center, to obtain a minimum radiation depth and maximum radiation depth at the point location center.

For each point location center, according to camera view angles at the point location center, multiple radiation rays can be projected to an imaging plane of each camera starting from the point location center, and multiple ray sampling points on each radiation ray can be obtained by adopting a corresponding ray sampling strategy.

Because radiation rays at each point location center will lose energy due to the obstruction of various particles in the light path propagation, for example, gas will block a part of radiation rays, while opaque solid will block all radiation rays, respective radiation ray at each point location center will have different light ray lengths according to whether they are blocked by real objects, that is, respective radiation ray at each point location center will have different radiation depths, and the number of ray sampling points on each radiation ray is limited.

Therefore, for each point location center, after having determined each radiation ray under the point location center, the present application can determine, for each radiation ray, the distance between each ray sampling point on the radiation ray and the point location center as depth information of each ray sampling point. Then, according to the depth information of each ray sampling point on the same radiation ray, depth rendering can be performed on the ray sampling points on this radiation ray, so as to obtain the radiation depth of this radiation ray.

Among them, the depth rendering formula for each ray sampling point on each radiation ray can be as follows:

$$depth = {\sum }_{n = 1}^{N} T ( {t}_{1} \to {t}_{n} ) * ( 1 - exp ( - {σ}_{n} ( {t}_{n + 1} - {t}_{n} ) ) ) * \frac{{t}_{n} + {t}_{n + 1}}{2}$$

Among them, when the depth rendering is performed on each ray sampling point on a certain radiation ray, the radiation depth of the radiation ray can be obtained by discrete summation with reference to the depth information of any ray sampling point on the radiation ray. In the present application, the middle point of adjacent ray sampling points

$$\frac{{t}_{n} + {t}_{n + 1}}{2}$$

may be used, or any ray sampling point can also be used, which is not limited in the present application.

Thus, in the same way as above, the radiation depth of each radiation ray at the point location center can be determined. Then, the minimum radiation depth and maximum radiation depth at the point location center can be determined by comparing the radiation depths of respective radiation rays at the point location center. With the point location center as the center, there will be no real objects in the three-dimensional scene in an area less than the minimum radiation depth and an area greater than the maximum radiation depth.

S320: based on the minimum radiation depth, the maximum radiation depth and a preset depth relationship between adjacent layers, determining the number of layers and the depth information of each layer at the point location center.

As far as the multi-sphere image at each point location center, users can be supported to move in a user roamable area represented by the point location, so as to watch the multi-sphere image presented around the point location center.

It can be understood that the radius of each point location should be less than the depth information of the first layer in the multi-sphere image at the point location center, so that users can comprehensively observe the overall spatial environment of the three-dimensional scene at the point location center.

When users watch the presented multi-sphere image in each point location, if any adjacent layer is too close, the content of a subsequent layer in the adjacent layers will have a certain impact on the viewing effect of the content of a previous layer. Therefore, in order to ensure the real accuracy of the reconstructed 3D scene, the present application can preset a depth relationship between adjacent layers, and set the depth interval between adjacent layers within a certain range to cancel the impact by the content of the previous layer on viewing of the content of the subsequent layer.

As shown in FIG. 4, taking adjacent layers rₗ and rₗ₊₁ at a certain point location center as an example, rₗ is the depth information of the previous layer in the adjacent layers and rₗ₊₁ is the depth information of the subsequent layer in the adjacent layers. The dotted area at the point location center can be a roamable area represented by the point location, and the initial radius of the point location is a preset desired roaming depth rᵢ.

When observing the same point on the layer rₗ at different positions within the point location, the observable line of sight will pass through the point on the layer rₗ and fall to different points on the layer rₗ₊₁. Then, in order to avoid impact by the content of the subsequent layer on the viewing effect of the content of the previous layer, it is required that the depth relationship between adjacent layers should satisfy that in the point location, the maximum pixel parallax of an observable line of sight for any pixel point of the previous layer in the adjacent layer, when falling on the subsequent layer in the adjacent layer, is less than or equal to the unit pixel.

At this time, as shown in FIG. 4, for any pixel on the previous layer rₗ in the adjacent layers, when the pixel on the layer rₗ is observed at two boundary tangent points tangent to the connecting line of the pixel in the roamable area represented by the point location, the pixel parallax of the two observable lines of sight when they fall on the subsequent layer in the adjacent layers is the largest. Then, the maximum pixel parallax is required to be less than or equal to the unit pixel.

From the above, assuming that the maximum pixel parallax is equal to the unit pixel, we can get

$$\frac{1}{r e s} = \frac{d}{2 π * {r}_{l + 1}} .$$

Where res is a preset texture resolution of the multi-sphere image, d is an arc length corresponding to the maximum pixel parallax on the subsequent layer rₗ₊₁.

Assume

$$ρ = \frac{res}{2 π} ,$$

then it can be inferred

$$d = \frac{{r}_{l + 1}}{ρ} .$$

Assuming that the included angle formed by two observable lines of sight corresponding to the maximum pixel parallax when they pass through the pixel on the previous layer rₗ is 2, it can be inferred that

$$φ = arcsin \frac{{r}_{i}}{{r}_{l}} , and tan φ = \frac{d / 2}{{r}_{i + 1} - {r}_{i}} .$$

It can be inferred from the above formula that the depth relationship between adjacent layers can be

$${r}_{l + 1} = {r}_{l} * \frac{tan φ}{tan φ - 1 / 2 ρ} .$$

Then, according to the formula of the depth relationship between adjacent layers as above, multiple layers can be divided between the minimum radiation depth and the maximum radiation depth at each point location center, so that on the basis that the depth of every two adjacent layers can satisfy the above formula, the depth information of the first layer is greater than or equal to the minimum radiation depth and the depth information of the last layer is less than or equal to the maximum radiation depth, thereby the number of layers and the depth information of each layer at the point location center can be obtained.

In some optional implementations, in order to ensure the accuracy of layer division at each point location center, the present application can determine the number of layers and the depth information of each layer at each point location center by the following steps: taking the minimum radiation depth as the depth information of the first layer and the first layer as the current layer; performing a multi-layer depth determination step: determining the depth information of a next layer based on the depth information of the current layer and a preset depth relationship between adjacent layers; taking the next layer as the new current layer, and continuing to perform the multi-layer depth determination step until the depth information of the latest layer is greater than or equal to the maximum radiation depth, so as to obtain the number of layers and the depth information of each layer at the point location center.

That is to say, at each point location center, the minimum radiation depth at the point location center can be taken as the depth information of the first layer, and the depth information of the second layer can be calculated according to the above formula satisfied by the depth relationship between adjacent layers. Then, take the second layer as the current layer, and continue to calculate the depth information of the third layer according to the formula satisfied by the depth relationship between adjacent layers, and cycle in turn to continuously calculate the depth information of the next layer until the depth information of a latest layer is greater than or equal to the maximum radiation depth at the point location center, and then stop dividing the layers. Thus, according to the result of layer division at the point location center, the number of layers and the depth information of each layer at the point location center can be obtained.

S330: based on the depth information of each layer and the depth information of the ray sampling points, performing multi-layer rendering on the color information of the ray sampling points to obtain a multi-sphere image reconstructed for the three-dimensional scene at the point location center.

After having determined the depth information of each layer at each point location center, by comparing the depth information of each layer at the point location center with the depth information of each ray sampling point at the point location center, a part of the ray sampling points that may affect the rendering result of each layer can be determined. Then, the color information of the part of the ray sampling points that may affect the rendering result of each layer can be projected on the layer for color rendering of each layer at the point location center, so as to obtain the rendered image on each layer at the point location center and form a multi-sphere image reconstructed for the three-dimensional scene at the point location center.

In some optional implementations, in order to ensure the accuracy of the multi-sphere image at each point location center, the present application can determine the multi-sphere image reconstructed for the three-dimensional scene at each point location center in the following ways: based on the depth information of each layer and the depth information of ray sampling points, determining associated ray sampling points of each layer; performing volume rendering on the color information of the associated ray sampling points of each layer, so as to obtain the multi-sphere image reconstructed for the three-dimensional scene at the point location center.

That is to say, by comparing the depth information of each layer at the point location center with the depth information of each ray sampling point at the point location center, the associated ray sampling point of each layer can be determined.

Among them, layer rendering can be classified into color rendering and transparency rendering, and the colors of all ray sampling points behind each layer will have a certain impact on the color rendering result of the layer, so the associated ray sampling points during color rendering of each layer can be the ray sampling points behind the layer.

However, the transparency rendering of each layer is only related to transparencies of ray sampling points between this layer and a subsequent layer, so the associated ray sampling points during transparency rendering of each layer can be ray sampling points between this layer and the subsequent layer.

Then, color rendering and transparency rendering of ray sampling points can be performed on each layer respectively. For the associated ray sampling points involved in color rendering of each layer, volume rendering can be performed on the color information in the color information of the associated ray sampling points. Moreover, for the associated ray sampling points involved in transparency rendering of each layer, volume rendering can be performed on the transparency information in the color information of the associated ray sampling points. After the color rendering and transparency rendering are completed, the multi-sphere image reconstructed for the three-dimensional scene at the point location center can be obtained.

For example, the formula for performing color rendering of ray sampling points on each layer rₘ can be:

$${c}_{l} = {\sum }_{n = 1}^{N} T ( {t}_{1} \to {t}_{n} ) * ( 1 - exp ( - {σ}_{n} ( {t}_{n + 1} - {t}_{n} ) ) ) * {c}_{n}$$

Where, tₗ=rₘ, t_{N}=d_{far}, d_{far} is the maximum radiation depth, which means that the associated sampling points involved in color rendering of the layer rₘ are all ray sampling points behind the layer.

The formula for performing transparency rendering of ray sampling points on each layer rₘ can be:

$${α}_{l} = {\sum }_{n = 1}^{N} T ( {t}_{1} \to {t}_{n} ) * ( 1 - exp ( - {σ}_{n} ( {t}_{n + 1} - {t}_{n} ) ) )$$

Where t₁=rₘ, t_{N}=rₘ₊₁, which means that the associated sampling points involved in transparency rendering of the layer rₘ are all ray sampling points between this layer rₘ and the subsequent layer rₘ₊₁.

According to the technical solution provided by embodiments of the present application, based on the minimum radiation depth, the maximum radiation depth and the preset depth relationship between adjacent layers at each point location center, performing layer division at the point location center, to perform multi-layer rendering on the color information of ray sampling points, so as to obtain a multi-sphere image reconstructed for the three-dimensional scene at the point location center, so that the accurate reconstruction of the three-dimensional scene at multiple point location centers can be realized, the virtual scene after three-dimensional scene reconstruction can be approximately represented locally by the multi-sphere images at the multiple point location centers, which ensures the true stereoscopic impression after 3D scene reconstruction, reduces the computational overhead of 3D scene reconstruction, and can also achieve accurate 3D scene reconstruction on middle and low-end XR equipment, thus ensuring the comprehensive applicability of 3D scene reconstruction.

According to one or more embodiments in the present application, because after the multi-sphere image reconstructed for the three-dimensional scene at each point location center has been obtained, it is necessary to present the multi-sphere image at each point location center on the client with low running performance, so that the user can immerse himself into the virtual scene at each point location center, in order to ensure efficient presentation of the multi-sphere image reconstructed for the three-dimensional scene at each point location center on the client, the present application can preset the number of layers as the preset upper limit of layers that the client can support the efficient presentation after the three-dimensional scene reconstruction.

Then, in the present application, after determining the number of layers and the depth information of each layer at each point location center based on the minimum radiation depth, the maximum radiation depth and the preset depth relationship between adjacent layers at the point location center, it is first necessary to judge whether the number of layers is less than or equal to the preset upper limit of layers.

If the number of layers at a certain point location center is greater than the preset upper limit of layers, it means that the client cannot guarantee the efficient presentation of the multi-sphere image at the point location center, then, aiming at the preset formula of the depth relationship between adjacent layers

$${r}_{l + 1} = {r}_{l} * \frac{tan φ}{tan φ - \frac{{φ}_{1}}{2 ρ}} , where φ = arcsin \frac{{r}_{i}}{{r}_{l}} ,$$

the present application can re-determine the number of layers and the depth information of each layer at the point location center based on the minimum radiation depth, the maximum radiation depth and the preset depth relationship between adjacent layers at the point location center by reducing the radius of the point location in the depth relationship between adjacent layers, so that the re-determined number of layers is less than or equal to the preset upper limit of layers.

That is to say, by reducing the radius of the point location in the depth relationship between adjacent layers from the initial value of the desired roaming depth continuously, the layers are re-divided between the minimum radiation depth and the maximum radiation depth according to the depth relationship between adjacent layers. At this time, in adjacent layers r^{l} and rₗ₊₁, by reducing the radius of the point in the depth relationship between adjacent layers, the included angle φ formed by two observable lines of sight corresponding to the maximum pixel parallax passing through a pixel on the previous layer rₗ can be reduced, so as to increase the depth interval between adjacent layers, thereby reducing the number of layers divided between the minimum radiation depth and the maximum radiation depth at the point location center, so that it can gradually become less than or equal to the preset upper limit of layers, thus re-determining the number of layers and the depth information of each layer at the point location center.

After re-obtaining the number of layers and depth information of each layer at each point location center, it is possible to continue to perform multi-layer rendering on the color information of the ray sampling points based on the depth information of each layer and the depth information of the ray sampling points, so as to get the multi-sphere image reconstructed for the three-dimensional scene at the point location center.

However, when such obtained multi-sphere image reconstructed for the three-dimensional scene at each point location center is presented to the user, the multi-sphere image at the point location center can be viewed normally only within the reduced radius range of the point location, while the multi-sphere image at the point location center may be subject to presentation distortion when viewed within the range from the reduced radius to the expected roaming depth within the point location.

Therefore, in order to ensure that the user can avoid the presentation distortion of the multi-sphere image at the each point location center at any position in each point location, after continuously reducing the radius of the point location in the depth relationship between adjacent layers from an initial value expressed by the expected roaming depth, so as to re-divide the layers at a certain point location center and obtain the multi-sphere image at the point location center, the present application also needs to optimize the multi-sphere image so that it can achieve distortion-free presentation in all points set by the expected roaming depth.

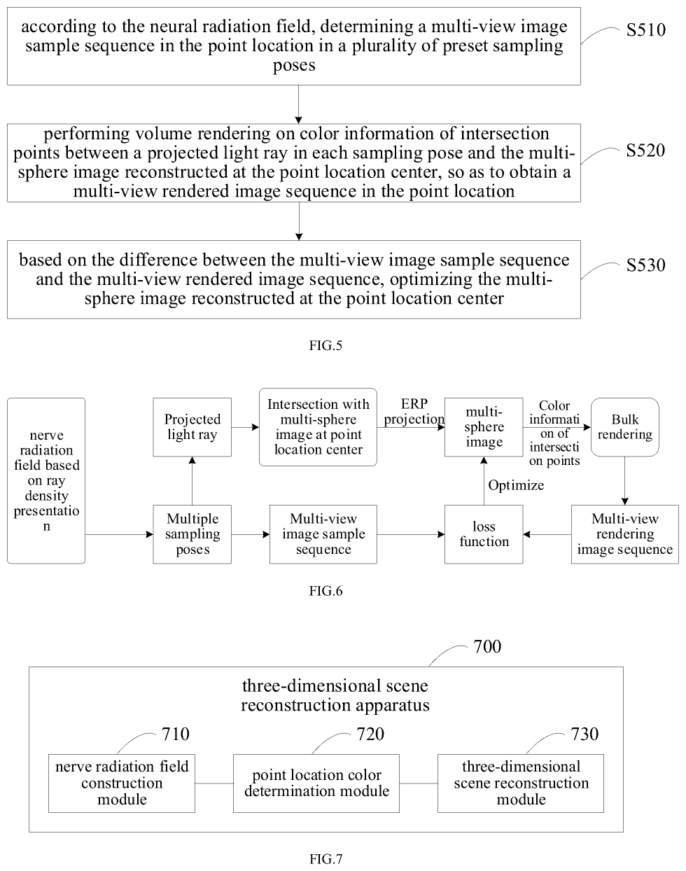

As shown in FIG. 5, the process of optimizing the multi-sphere image reconstructed for the three-dimensional scene at any point location center can be explained:

S510, according to the neural radiance field, determining a multi-view image sample sequence in the point location in a plurality of preset sampling poses.

If the present application continuously reduces the radius of the point location in the depth relationship between adjacent layers from an initial value expressed by the expected roaming depth so as to re-divide the layers at a certain point location center, then, for the point location center, the present application can reset multiple sampling poses in the point location. Moreover, the present application can analyze particle information, such as color, bulk density, illumination intensity, material and the like, of each ray sampling point on each radiation ray formed at the point location center in the neural radiance field of the three-dimensional scene, and can re-generate the scene image in each sampling pose, thus forming a multi-view image sample sequence in the point location in multiple sampling poses.

Among them, the multi-view image sample sequence can represent real scene images that the three-dimensional scene can acquire from sampling poses in the point location.

S520: performing volume rendering on color information of intersection points between a projected light ray in each sampling pose and the multi-sphere image reconstructed at the point location center, so as to obtain a multi-view rendered image sequence in the point location.

In the neural radiance field, light rays can be projected according to sampling angles of view in the point location. Then, as shown in FIG. 6, the projected light ray in each sampling pose will intersect with the multi-sphere image reconstructed at the point location center, and the coordinate of the intersection point of each projected light ray on each layer of spherical shell image can be determined by means of Equirectangular Projection (abbreviated as ERP), so as to determine the color information of each intersection point from appearance information of the three-dimensional scene.

Then, for each sampling pose, the following volume rendering formula designed in the neural radiance field can be used to perform volume rendering on color information of intersection points between the projected light rays in the sampling pose and each layer of sphere image at the point location center, so as to obtain the rendering result in each sampling pose in the point location, thereby form the multi-view rendered image sequence in the point location.

Exemplary, the following volume rendering formula designed in the neural radiance field can be:

$${c}_{r} = {\sum }_{i = 1}^{n} {α}_{i} {c}_{i} {\prod }_{j = i + 1}^{n} ( 1 - {α}_{j} ) .$$

Among them, n in the multi-sphere image can be arranged from far to near according to the distance between each layer and the point location, cᵢ can indicate color information of an intersection point between a light ray projected according to a certain sampling pose in the point location and each layer i of sphere image in the multi-sphere image, a₁ indicates opacity information of a corresponding intersection point, which can be expressed by the bulk density of the intersection point.

S530: based on the difference between the multi-view image sample sequence and the multi-view rendered image sequence, optimizing the multi-sphere image reconstructed at the point location center.

After the multi-view rendered image sequence is obtained by rendering the multi-sphere image in respective sampling poses, the color information and opacity information of each pixel in the multi-sphere image are continuously adjusted by comparing differences between an image in the multi-view rendered image sequence and an image in the multi-view image sample sequence belonging to the same sampling pose and employing a corresponding loss function, so that the two images in the multi-view rendered image sequence and in the multi-view image sample sequence belonging to the same sampling pose can be consistent, thereby obtaining the optimized multi-sphere image at the point location center, which supports users to accurately watch the multi-sphere image of the three-dimensional scene at each point location center at any position point within each point without distortion, and ensuring the accuracy of the multi-sphere image of the three-dimensional scene at each point location center.

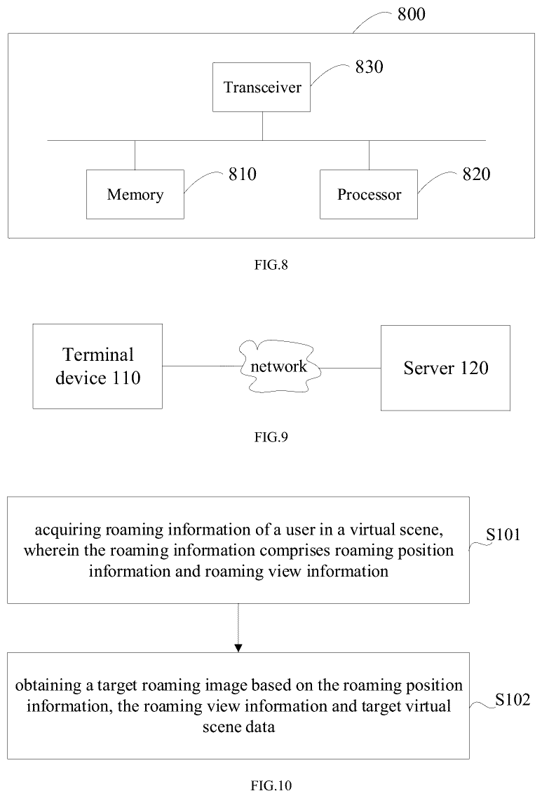

FIG. 7 is a schematic block diagram of a three-dimensional scene reconstruction apparatus provided by an embodiment of the present application. As shown in FIG. 7, the three-dimensional scene reconstruction apparatus 700 may include:
a neural radiance field construction module 710, configured to construct a neural radiance field for a three-dimensional scene based on a multi-view image sequence in the three-dimensional scene;
a point location color determination module 720, configured to, for each given point location center, determine ray sampling points at the point location center and color information of the ray sampling points based on the neural radiance field;
a three-dimensional scene reconstruction module 730, configured to perform multi-layer rendering on the color information of the ray sampling points to obtain a multi-sphere image reconstructed for the three-dimensional scene at the point location center.

In some optional implementations, the three-dimensional scene reconstruction module 730 may include:
a radiation depth determination unit, configured to perform depth rendering on ray sampling points of each radiation ray at the point location center, to obtain a minimum radiation depth and maximum radiation depth at the point location center;
a layer division unit, configured to determine the number of layers and the depth information of each layer at the point location center based on the minimum radiation depth, the maximum radiation depth and a preset depth relationship between adjacent layers;
a multi-sphere image rendering unit configured to, based on the depth information of each layer and the depth information of the ray sampling points, perform multi-layer rendering on the color information of the ray sampling points to obtain a multi-sphere image reconstructed for the three-dimensional scene at the point location center.

In some optional implementations, the layer division unit can be specifically configured to:
take the minimum radiation depth as the depth information of a first layer and take the first layer as the current layer;
perform a multi-layer depth determination step: determining the depth information of a next layer based on the depth information of the current layer and a preset depth relationship between adjacent layers;
take the next layer as the new current layer, and continue to perform the multi-layer depth determination step until the depth information of the latest layer is greater than or equal to the maximum radiation depth, so as to obtain the number of layers and the depth information of each layer at the point location center.

In some optional implementations, the multi-sphere image rendering unit can be specifically configured to:
based on the depth information of each layer and the depth information of ray sampling points, determine associated ray sampling points of each layer;
perform volume rendering on the color information of the associated ray sampling points of each layer, to obtain the multi-sphere image reconstructed for the three-dimensional scene at the point location center.

In some optional implementations, the depth relationship between adjacent layers satisfies that in the point location, the maximum pixel parallax of an observable line of sight for any pixel point of the previous layer in the adjacent layer, when falling on the subsequent layer in the adjacent layer, is less than or equal to the unit pixel.

In some optional implementations, an initial radius of the point location is a preset expected roaming depth, and if the number of layers at the point location center is greater than a preset upper limit of layers, the 3D scene reconstruction apparatus 700 may further include a layer updating module, which can be configured to:
re-determine the number of layers and the depth information of each layer at the point location center based on the minimum radiation depth, the maximum radiation depth and the preset depth relationship between adjacent layers at the point location center by reducing the radius of the point location in the depth relationship between adjacent layers, so that the re-determined number of layers is less than or equal to the preset upper limit of layers.

In some optional implementations, the three-dimensional scene reconstruction apparatus 700 may further include a multi-sphere image optimization module which may be configured to:
according to the neural radiance field, determine a multi-view image sample sequence in the point location in a plurality of preset sampling poses,
perform volume rendering on color information of intersection points between a projected light ray in each sampling pose and the multi-sphere image reconstructed at the point location center, so as to obtain a multi-view rendered image sequence in the point location.
based on the difference between the multi-view image sample sequence and the multi-view rendered image sequence, optimize the multi-sphere image reconstructed at the point location center.

In some implementations, the neural radiance field is expressed based on light ray density.

In some optional implementations, the point location color determination module 720 can be specifically configured to:
for each given point location center, determine the radiation light ray and the ray sampling points on the radiation light ray at the point location center according to the neural radiance field;
determine the color information of the ray sampling point according to the neural radiance field.

In some optional implementations, the three-dimensional scene reconstruction apparatus 700 may further include an image display module which may be configured to:
acquire information about roaming pose of the user, which includes the roaming position and roaming posture;
if the roaming position is within the point location, display a corresponding roaming image according to the roaming pose information and the multi-sphere image reconstructed at the point location center.

In the embodiments of the present application, firstly, a multi-view image sequence in a three-dimensional scene may be processed to construct a neural radiance field for a three-dimensional scene. Then, for each given point location center, ray sampling points at the point location center and color information of each ray sampling point may be determined based on the neural radiance field, and multi-layer rendering is performed on the color information of the ray sampling points to obtain a multi-sphere image reconstructed for the three-dimensional scene at the point location center, thus realizing accurate reconstruction of the three-dimensional scene at the multiple point location centers. The virtual scene after three-dimensional scene reconstruction can be approximately represented locally by the multi-sphere images at the multiple point location centers, which ensures true stereoscopic impression after three-dimensional scene reconstruction, reduces computational overhead of three-dimensional scene reconstruction, and can also achieve accurate reconstruction of three-dimensional scene on middle and low end XR devices, thus ensuring the comprehensive applicability of three-dimensional scene reconstruction.

It should be understood that the apparatus embodiment and the method embodiment in the present application can correspond to each other, and similar descriptions can refer to the method embodiment in the present application, and will not be repeated herein for avoiding repetition.

Specifically, the apparatus 700 shown in FIG. 7 can execute the three-dimensional scene reconstruction according to any method embodiment provided by the present application, and the aforementioned and other operations and/or functions of each module in the apparatus 700 shown in FIG. 7 are respectively to realize the corresponding flow of the above method embodiment related to the three-dimensional scene reconstruction, and are not repeated here for brevity.

Hereinafter the schemes related to virtual scene display according to an embodiment of the present application will be described in detail.

With continuous development of Extended Reality (XR) technology, XR technology has been widely applied in various scene experiences, for example, roaming virtual reality scenes such as houses, tourist attractions and buildings, enabling the public to roam around the world without leaving home through electronic devices that provide virtual scenes.

At present, the virtual scene roaming uses 3-degree-of-freedom panoramic images, so users can watch the 3-degree-of-freedom panoramic images only at fixed roaming point locations when roaming in the virtual scene, that is, to realize 3-degree-of-freedom roaming. However, this 3-degree-of-freedom roaming makes the user's roaming in the virtual scene to be not stereoscopic, which leads to poor immersivity in the scene roaming.

At present, users can watch 3 degree of freedom panoramic images only at fixed roaming point locations when the users roam in a virtual scene based on an electronic device, which makes user's roaming in the virtual scene be not stereoscopic and leads to poor immersivity of scene roaming. In order to solve the above technical problems, the inventive concept of the present application is: performing three-dimensional reconstruction of a real scene by using a neural radiance field (abbreviated as NeRF) to obtain a virtual scene with real stereoscopic effect, and then when a user roams in the virtual scene, displaying a corresponding high-fidelity and stereoscopic roaming image to the user according to the roaming information of the user, so that the user roams in the virtual scene with more stereoscopic effect, thereby improving the immersivity of the user roaming in the virtual scene and achieving an immersive roaming experience.

It should be understood that the technical scheme of the present application can be applied to but not limited to the following scenarios:

As shown in FIG. 9, the application scenario may include a terminal device 110 and a server 120. The terminal device 110 can communicate with the server 120 through a network to realize data interaction.

In some alternative embodiments, the terminal device 110 may be various electronic devices capable of providing virtual scenes and virtual scene roaming functions, for example, VR devices, XR devices, smart phones (such as Android phones, IOS phones, WindowsPhone phones, etc.), tablet computers, notebook computers, ultra-mobile personal computer (UMPC), personal digital assistant (PDA), etc., the present application does not impose specific restrictions on the types of electronic devices. It should be understood that in the present application, the terminal device 110 can also be called User Equipment (UE), a terminal or a user device, etc., which is not limited herein.

When the terminal device 110 is a virtual scene product such as a VR device or an XR device, it is preferably a head mounted display (HMD) under the VR device or the XR device.

In some alternative embodiments, the server 120 may be various servers, such as traditional server and cloud server. Among them, a traditional server can optionally be, but not limited to, a file server and a database server.

In an application scenario, the terminal device 110 can, based on the user's trigger operation on any one virtual scene, obtain three-dimensional model data (i.e. virtual scene data) corresponding to the virtual scene from the server 120 or a storage module of the terminal device 110, so that the user can enter the virtual scene and render a corresponding roaming image according to the user's roaming information in the virtual scene, that is, render a corresponding target virtual scene image based on the user's real-time pose in the virtual scene, so that the user can get a more stereoscopic and immersive roaming experience in the virtual scene.

It should be noted that the terminal device 110 and the server 120 shown in FIG. 9 are only schematic, and the number and types of the terminal device 110 and the server 120 can be adjusted according to actual usage needs, and are not limited to those shown in FIG. 9.

After having introduced the application scenario of the present application, the technical scheme of the present application will be described in detail below.

FIG. 10 is a flowchart of a method of displaying a virtual scene provided by an embodiment of the present application. The virtual scene display method provided by the present application can be executed by a virtual scene display apparatus. The virtual scene display apparatus can be composed of hardware and/or software, and can be integrated into the terminal device. As shown in FIG. 10, the method may include the following steps:

S101, acquiring roaming information of a user in a virtual scene, wherein the roaming information comprises roaming position information and roaming view information.

In the present application, a virtual scene can be interpreted as a three-dimensional model obtained by performing a three-dimensional geometric space reconstruction for any real scene. Among them, the real scene can be houses, tourist attractions or other buildings.

The above three-dimensional geometric space reconstruction for the real scene can be carried out by Multi-View Stereo (abbreviated as MVS) reconstruction, or by NeRF, etc. The present application does not impose any restriction on the three-dimensional reconstruction for the real scene.

Considering when the real scene is three-dimensional reconstructed by MVS reconstruction, there may be a weak texture area in each image in the multi-view image sequence, it is difficult for MVS reconstruction to represent subtle and complex geometric structures in the real scene. Moreover, the textures of each image in the multi-view image sequence are also difficult to reproduce the detailed information, such as illumination and materials, in the real scene with high fidelity.

NeRF is a kind of radiance field that represents a three-dimensional scene as an approximation by a neural network, and can accurately describe the color information and volume density (that is, bulk density) of each spatial point in the real scene in each observation direction, thus have more advantages over MVS reconstruction in terms of realism of rendering and reduction of complex geometric structures. Therefore, in the present application, NeRF is preferably used to reconstruct the real scene, so as to obtain a three-dimensional model with high-fidelity appearance and finer geometric structure.

In some alternative embodiments, when the real scene is reconstructed by NeRF, the present application may firstly set acquisition devices having capturing functions, such as camera head or camera, in at least one position in the real scene, so as to implement omnidirectional image acquisition of the real scene from multiple views through the acquisition devices at each position, so as to obtain multiple frames of real environment images in the real scene. Then, the multi-frame real environment images can serve as the multi-view image sequence for three-dimensional reconstruction in the present application.

Furthermore, according to the multi-view image sequence, Nerf carries out three-dimensional reconstruction for the real scene to obtain the corresponding virtual scene. It should be understood that the three-dimensional reconstruction for the real scene by NeRF is to construct the neural radiance field of the real scene, so as to implement the high-precision and high-fidelity modeling of the real scene through the neural radiance field.

As an optional implementation, NeRF obtains the neural radiance field corresponding to the real scene according to the multi-view image sequence in the real scene, the specific implementation process is as follows: by analyzing the camera position and camera orientation corresponding to each view image in the multi-view image sequence, a corresponding radiation ray can be formed facing each pixel in an imaging plane of the acquisition device starting from the position of the acquisition device, so that a plurality of radiation rays under the multi-view image sequence can be obtained. For each radiation ray, a corresponding ray sampling strategy can be adopted, and a plurality of ray sampling points can be continuously sampled on that radiation ray. Then, by processing the texture features in each real scene image in the multi-view image sequence, the color information and volume density of each ray sampling point on each radiation ray can be predicted, thus obtaining the neural radiance field corresponding to the real scene.

It should be understood that the above multi-view image sequence can form a panoramic image of the real scene after being arranged according to the corresponding shooting angles, so that the geometric structure and appearance information of the real scene can be comprehensively understood.

Considering that although NeRF has more advantages in terms of reduction of geometric structure and realism of rendering, it is difficult to estimate the geometric structure directly by extracting zero-value surfaces because the real scene is not a strict surface structure. Therefore, in order to accurately describe the geometric structure and real rendering texture of the real scene, the present application can express two different neural radiance fields that can independently predict the geometric information and appearance information of the real scene in two different ways with respect to the differences between the geometric structure and the image texture. Then, these two preliminarily constructed neural radiance fields expressed in different ways are trained by using the multi-view image sequence in the real scene, to obtain the geometric neural radiance field and the appearance neural radiance field in the present application respectively.

Among them, for the geometric neural radiance field, a preliminarily constructed neural radiance field can be trained by taking the acquired multi-view images as training samples, and the scene geometric structure therein can be continuously analyzed during the training process, so that after the training is completed, the geometric neural radiance field can be used to accurately estimate the geometric information of the real scene. For the appearance neural radiance field, a preliminarily constructed neural radiance field can be trained by taking the acquired multi-view images as training samples, and the scene appearance information therein can be continuously analyzed during the training process, so that after the training is completed, the appearance neural radiance field can be used to accurately estimate the high-fidelity appearance information of the real scene.

That is, the geometric neural radiance field can be expressed as a relative distance between each ray sampling point on each radiation ray in the real scene and the nearest real object in the real scene, so as to express the geometric structure of each real object in the real scene.

The above-mentioned appearance neural radiance field can include particle information, such as color, bulk density, illumination intensity, material and so on, of each ray sampling point on each radiation ray in the real scene, so as to represent the actual texture of each real object in the real scene.

In some alternative implementations, in order to ensure that the geometric structure of the real scene is highly reduced, the present application can represent the geometric neural radiance field based on Signed Distance Fields (abbreviated as SDF). Among them, SDF refers to the establishment of a spatial field, and the value of each voxel in the spatial field can represent the distance between the voxel and a nearest geometric image in the spatial field (that is, the geometric surface figure of each real object in the real scene). If the voxel is inside the real object, the distance is set as negative, if the voxel is outside the real object, the set distance is set as positive, and if the voxel is on the boundary of the geometric surface graph of the real object, the distance is set as zero.

Therefore, when a geometric neural radiance field based on SDF is trained, a corresponding geometric feature processing is performed on the multi-view image sequence to analyze the distance between each ray sampling point in the real scene and the nearest geometric surface figure of each real object, so as to extract each ray sampling point with zero distance, so that the geometric neural radiance field of the real scene can be obtained.

In order to ensure high-fidelity appearance information of the real scene, the present application can express the appearance neural radiance field based on the light ray density, and analyze the particle information such as color, bulk density, illumination intensity and material, of each ray sampling point in the real scene to generate the appearance neural radiance field of the real scene to represent the high-fidelity appearance information of the real scene.

As an alternative implementation, the present application can obtain the geometric neural radiance field of the real scene through the following steps:

Step 1, inputting the multi-view image sequence in the real scene into a trained geometric prior model to obtain geometric prior information of the real scene.

In order to ensure the accuracy of the geometric structure reconstruction of the real scene, the present application can additionally train a geometric prior model, which is used to analyze the spatial structure, depth and other information of the real scene through image feature processing, as an additional constraint condition during the training of the geometric neural radiance field to ensure the accuracy of the geometric neural radiance field of the real scene.

Therefore, for the multi-view image sequence in the real scene, the present application can first input the multi-view image sequence into the trained geometric prior model, so as to predict geometric prior information of the real scene, such as normal vector, depth information, etc., through utilizing the geometric prior model to perform a corresponding feature processing on each real environment image in the multi-view image sequence in advance, thereby providing an additional constraint for the training of the geometric neural radiance field and ensuring construction accuracy of the geometric neural radiance field of the real scene.

Step 2, obtaining the geometric neural radiance field of the real scene based on the multi-view image sequence and the geometric prior information.

After having obtained the geometric prior information of the real scene, the multi-view image sequence and the geometric prior information can be comprehensively analyzed, so that the geometric structure features in each real environment image in the multi-view image sequence can be processed accordingly under the additional constraint of the geometric prior information, and thus the geometric neural radiance field of the real scene can be accurately constructed.

Therefore, by structurizing each geometric information represented in the geometric neural radiance field of the real scene, a three-dimensional mesh model (denoted as Mesh) of the real scene can be generated, which is convenient for users to roam in the three-dimensional mesh model subsequently.

In some alternative embodiments, the three-dimensional mesh model of the real scene in the present application can also be generated based on MVS reconstruction or other manners, and the present application does not impose any restrictions on this.

It should be noted that in the present application, obtaining a virtual scene by three-dimensional reconstruction of a real scene can be realized on a terminal device, or can also be realized on a server connected with the terminal device in communication, and the present application does not impose any restrictions on this. Considering that the performances of various devices or components of the terminal device are lower than that of the server, and various processing processes need to be carried out on the terminal device, while virtual scene reconstruction needs to occupy a lot of computing resources, therefore, the present application preferably configures the operation of 3D reconstruction of the real scene on the server side, which can reduce the resource occupation of the terminal device, reduce the computing overhead of the terminal device, and improve the performance of the terminal device.

In exemplary implementations of step S101, the user can select any virtual scene from a plurality of virtual scenes provided by the terminal device, so that the terminal device can wake up the virtual scene in a dormant state and control the user to enter the virtual scene. Alternatively, the terminal device can obtain three-dimensional model data (virtual scene data) of the virtual scene from the server, so as to load the virtual scene based on the virtual scene data and control the user to enter the loaded virtual scene. In turn, users can roam in the virtual scene.

Considering that multiple users can enter a virtual scene at the same time, each user can enter the virtual scene in the form of a virtual object, so that one user can see other users' walking actions or other roaming interactive operations in the virtual scene. The virtual object corresponding to each user can be automatically assigned by the terminal device according to a default rule, or it can also be a personalized virtual object created by the user based on an object creation function provided by the terminal device, and the present application does not impose any restrictions on this.

In some alternative embodiments, when the user enters the virtual scene, the user can optionally enter a birth roaming point location first, and then the user can move from the birth roaming point location to other roaming point locations, so that the user can roam in the virtual scene starting from the birth roaming point location, so as to make the roaming image corresponding to the virtual scene display more orderly and obtain better experience.

The above-mentioned birth roaming point location can alternatively be a roaming point location located at the entrance of the virtual scene, or a roaming point location at the central position, or a roaming point location at any other position, etc., and the present application does not impose any restrictions on this.

It should be understood that the roaming point location can be a specific position point or a roaming area. When the roaming point location is the roaming area, the roaming area can be a cylindrical space or a spherical space. Among them, when the roaming area is a cylindrical space, the cylindrical space is constructed by setting a position point as the center, determining upper and lower parallel bottom surfaces with a first distance as the radius, and setting a second distance as the height. When the roaming area is a spherical space, the spherical space is obtained with a position point as the center and a third distance as the radius. The first distance, the second distance and the third distance are all adjustable parameters, which can be flexibly set according to scene roaming requirements.

In some alternative embodiments, the user roaming in the virtual scene will trigger a movement operation, for example, when the user moves from the birth roaming point location to other roaming point locations, the user can use a rocker to control the moving direction to implement movement to the target roaming point location, or can click on a target roaming point location to implement movement, or can also gaze at the target roaming point location for a preset duration by eye tracking to implement movement, or the like. Among them, controlling the movement by using the rocker can be applied to the operation via the touch screen, keyboard or handle. Controlling the movement by clicking is applied to the operation via finger touch click or mouse click. The above target roaming point location can be understood as a point location to which the user wants to move.

When the user roams in the virtual scene, the terminal device can obtain the roaming information of the user, i.e., roaming position information and roaming view information, in real time. Then, based on the obtained roaming position information and roaming view information, a corresponding roaming image is displayed to the user, so that a corresponding virtual scene image can be displayed based on the user's location, thus providing the user with a more immersive and stereoscopic roaming experience. Among them, the roaming view information includes angle of vision and line-of-sight orientation.

In the present application, the roaming pose information of the user can be determined based on Inertial Measurement Unit (abbreviated as IMU) data acquired by the inertial measurement unit in the terminal device, or it can be obtained through calculation based on environmental images acquired by the image acquisition device of the terminal device, specific determination of the roaming pose information can refer to the existing scheme, and will not be repeated here.

S102, obtaining a target roaming image based on the roaming position information, the roaming view information and target virtual scene data.

Among them, the target virtual scene data is determined based on the roaming position information and the virtual scene data, and the virtual scene data comprises a neural radiance field generated at least partially based on a real scene.

Considering that there will be some important positions or areas that are often observed by users in the real scene, such as corridor, doorway or living room, and some unimportant positions or areas that are not often observed by users, such as wall corners and corners, in the present application, when the real scene is reconstructed by using the neural radiance field, optionally, the important positions or areas in the real scene that are often observed by users can be reconstructed with high precision and high fidelity, and the unimportant positions or areas that are not often observed by users can be reconstructed by using a traditional three-dimensional reconstruction method, such as MVS reconstruction method or binocular stereo vision reconstruction method, so that the reconstruction calculation overhead for the real scene can be reduced. Of course, in order to obtain a high-fidelity high-precision virtual scene, the present application can also use the neural radiance field to model each position or area in the real scene, and the present application does not impose any restrictions on this.

The above virtual scene data can be understood as 3D model data for 3D reconstruction of any real scene.

The above-mentioned neural radiance field is a radiance field that represents a three-dimensional scene as an approximation by a neural network.

In order to obtain a roaming image corresponding to the roaming information of the user, the present application firstly obtains the target virtual scene data from the virtual scene data corresponding to the virtual scene based on the roaming position information, and then, based on the roaming position information and the roaming view information, determines an image corresponding to the target virtual scene data for rendering and displays the rendered target roaming image.

That is, based on the roaming position information and the roaming view information of the user in the virtual scene, the present application can display the virtual scene images corresponding to the roaming position information and the roaming view information to the user, so that the user can obtain a stereoscopic and immersive roaming experience when roaming in the virtual scene.

According to the technical scheme provided by embodiments of the present application, the roaming position information and the roaming view information of the user in the virtual scene are acquired to obtain the target virtual scene data based on the roaming position information and the roaming view information, and in turn the target roaming image is obtained based on the roaming position information, the roaming view information and the target virtual scene data, so that the user can have a more stereoscopic effect when roaming in the virtual scene, the immersivity of the user roaming in the virtual scene can be improved, and an immersive roaming experience can be achieved.

In another alternative implementation scenario, considering that there are roaming point locations configured in the virtual scene, the present application, when obtaining the target virtual scene based on the roaming position information and roaming view information of the user in the virtual scene, can first determine which roaming point location the user is currently located at based on the roaming position information of the user, and then obtain the target virtual scene data based on the roaming point location, so as to obtain the target virtual scene data based on the roaming point location where the user roaming position information is located. With reference to FIG. 11, the acquisition of target virtual scene data will be described in detail.

As shown in FIG. 11, the method comprises the following steps:

S201, acquiring roaming information of a user in a virtual scene, wherein the roaming information includes roaming position information and roaming view information.

S202, determining whether the roaming position information is located at a first type of roaming point location, if so, step S203 is executed, otherwise, step S204 is executed.

In order to facilitate the roaming interactive operation of users in the virtual scene, the present application can set a plurality of first types of roaming point locations and a plurality of second types of roaming point locations in the virtual scene, so that users can roam in the virtual scene based on these roaming point locations.

Among them, the first type of roaming point locations can be a plurality of default point locations that are preset in the real scene. The second type of roaming point location can be a plurality of custom point locations that after a virtual scene reconstructed from the real scene has been displayed to the user, are selected by the user in the displayed virtual scene, and the position information corresponding to each custom point location is obtained. It should be noted that the user who selects multiple custom point locations here refers to a content producer who carries out three-dimensional reconstruction of the real scene.

It should be understood that both the above-mentioned first type of roaming point location and the second type of roaming point location can support the user's 6-degree-of-freedom roaming operation at this point location, that is, when the user roams at any roaming point location, the user can realize the 6-degree-of-freedom roaming mode of changing the roaming position and changing the roaming view. It should be understood that there may be only the first type of roaming point locations without the second type of roaming point locations in the virtual scene, that is, the user can only switch between the first type of roaming point locations in the virtual scene.

In addition, the above-mentioned first type of roaming point locations can also support the personalized setting requirements of the content producer, specifically, the content producer can mark key points in the virtual scene and regard the marked key points as the first type of roaming point locations, so that when the preset default points in the virtual scene do not meet the scene production requirements, the content producer can personalize the default points in the virtual scene to meet different virtual scene production requirements.

The above-mentioned second type of roaming point locations specifically refer to points other than the first type of roaming point locations. That is, the second type of roaming point location is an arbitrary point location other than the first type of roaming point location. Moreover, the arbitrary point can be understood as an arbitrary position point.

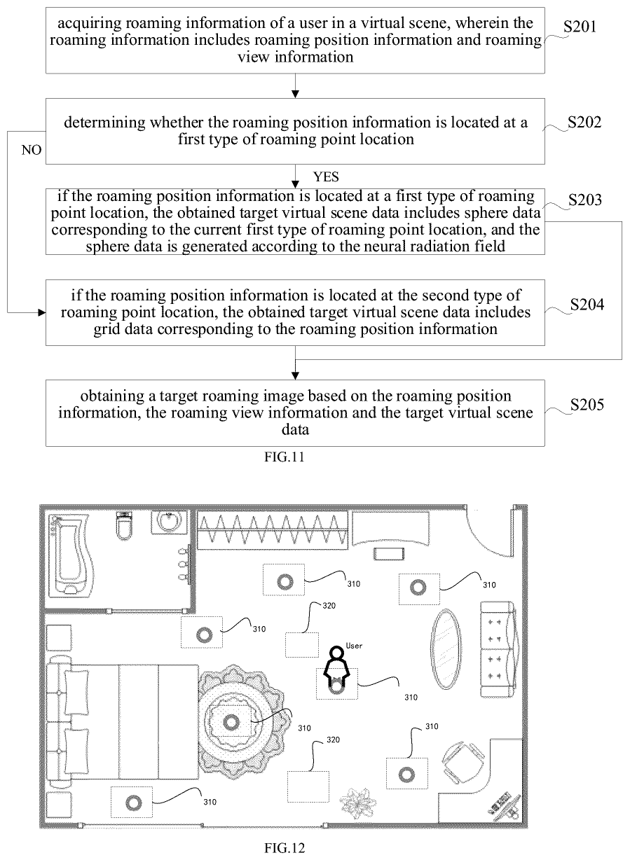

For example, assuming that the real scene is a house, the virtual scene of the house can be as shown in FIG. 12. A plurality of first type of roaming point locations 310 and a plurality of second type of roaming point locations 320 are set in the virtual scene shown in FIG. 12.

Therefore, after having obtained the roaming position information and the roaming view information of the user in the virtual scene, the present application can determine which roaming point location the user is currently located at based on the roaming position information, and then obtain the target virtual scene data based on the roaming point location where the user is currently located.

Note that each first type of roaming point location in the virtual scene corresponds to a roamable area, the roamable area can be a circular area, which can be used for roaming, and which is determined with a certain position point as the center point and a preset observation distance as the radius. Among them, the preset observation distance is an adjustable parameter, which can be flexibly adjusted according to roaming requirements.

Therefore, when determining which roaming point location the user is currently located at based on the roaming position information, the present application can first determine boundary position points of a roamable area corresponding to each first type of roaming point location, and compare the roaming position information of the user with the boundary position points of the roamable area corresponding to each first type of roaming point location. If the roaming position information of the user is located in a position range formed by the boundary position points of the roamable area corresponding to any first type of roaming point location, it is determined that the user is currently located at the first type of roaming point location. If the roaming position information of the user is not located in a position range formed by the boundary position points of the roamable area corresponding to all first type of roaming point location, it is determined that the user is currently located at any second type of roaming point location.

S203, if the roaming position information is located at a first type of roaming point location, the obtained target virtual scene data includes sphere data corresponding to the current first type of roaming point location, and the sphere data is generated according to the neural radiance field.

Among them, a current first type of roaming point location can be understood as when the roaming position information of the user is located in the roamable area of a certain first type of roaming point location, such a certain first type of roaming point location is the current first type of roaming point location, that is, the first type of roaming point location where the user is currently located.

Note that the first type of roaming point location can be a preset default point, and the default point can support users to perform 6 degree-of-freedom roaming with changing position and changing angle of view at this point location. Moreover, because each first type of roaming point location in the virtual scene corresponds to sphere data, the target virtual scene data obtained based on the roaming position information includes sphere data corresponding to the current first type of roaming point location.

In the present application, sphere data is a multi-sphere data (may be equivalent to multi-sphere image, abbreviated as MSI) generated for the first kind of roaming point locations based on neural radiance field. That is, the first type of current roaming point location is input into the neural radiance field to generate the multi-sphere data corresponding to the center point of the current first type of roaming point location through the neural radiance field.

Among them, multi-sphere data MSI is a kind of data format that extends Multi-Plane Image (abbreviated as MPI) to 360 spherical surfaces. In the present application, when three-dimension reconstruction is performed for the real scene, by reconstructing a multi-layer sphere image at each first type of roaming point location in the real scene, a multi-sphere image that is presented around at each point location center in the real scene can be realized, which enhances the real stereoscopic impression of the reconstructed real scene.

In some alternative embodiments, the first type of roaming point location in the virtual scene may include a central area and a boundary area, and optionally, the central area may be a circular area which is determined with a center point of a roamable area corresponding to the first type of roaming point location as the center of circle and a distance smaller the radius of the roamable area as the radius. The above-mentioned distance value is an adjustable parameter, as long as it can be less than the radius of the roamable area. Correspondingly, the boundary area can be a ring region which is obtained by subtracting the central area from the roamable area corresponding to the first type of roaming point location and is concentric with the central area.

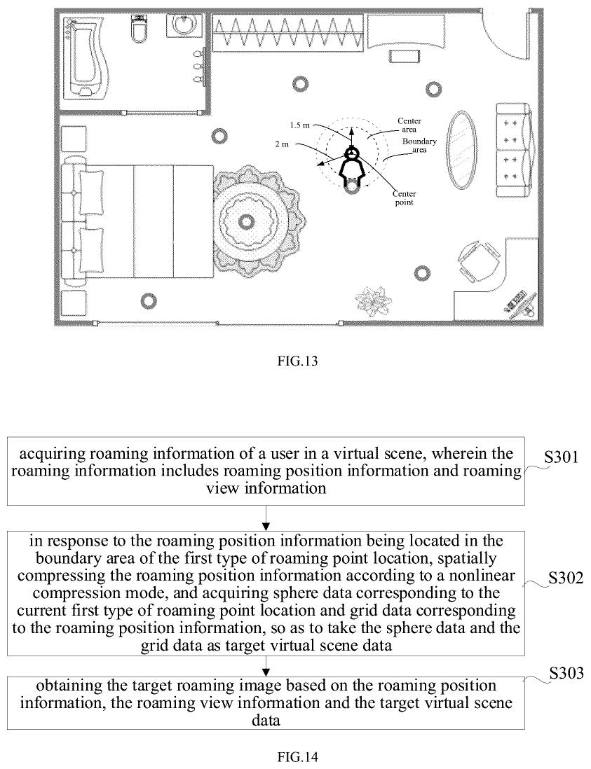

For example, as shown in FIG. 13, assuming that the center point of the roamable area corresponding to the first type of roaming point location is (X, Y) and the radius of the roamable area is 2 m, then the central area of the first type of roaming point location can be defined as a circular area Q1 with the center point (X, Y) as the center of circle and a distance value of 1.5 m less than the radius of the roamable area as the radius. Correspondingly, the boundary area of the first type of roaming point location is a ring area Q2 which is concentric with the circular area Q1 and is obtained by subtracting the circular area Q1 from the roamable area corresponding to the first type of roaming point location. The concentric point of the circular area Q1 and the ring area Q2 is the center point (x, y) of the first type of roaming point location.

It should be understood that the sizes of the central area and the boundary area of the first type of roaming point location can be flexibly adjusted according to actual roaming requirements, and the present application does not make any constraint thereon.

Therefore, when the roaming position information is located at the first type of roaming point location, obtaining the target virtual scene data may include the following steps:

Step S11: Detect whether the roaming position information is located in the central area of the current first type of roaming point location, if the roaming position information is located in the central area of the current first type of roaming point location, execute step S12, if the roaming position information is located in the boundary area of the current first type of roaming point location, execute step S13.

In some alternative embodiments, firstly, the boundary position points of the central area of the current first type of roaming point location and the boundary position points of the boundary area of the current first type of roaming point location are determined. Then, the roaming position information is compared with the boundary position points of the central area and the boundary position points of the boundary area respectively. If the roaming position information is located in the position range formed by the boundary position points of the central area, it is determined that the user is located in the central area of the current first type of roaming point location. If the roaming position information is located in the position range formed by the boundary position points of the boundary area, it is determined that the user is located in the boundary area of the current first type of roaming point location.

Step S12: If it is detected that the roaming position information is located in the central area of the current first type of roaming point location, the sphere data corresponding to the current first type of roaming point location is obtained as the target virtual scene data.

Step S13: If it is detected that the roaming position information is located in the boundary area of the current first type of roaming point location, the sphere data corresponding to the current first type of roaming point location and grid data corresponding to the roaming position information are obtained as the target virtual scene data.

The above grid data is generated based on the three-dimensional grid model of the real scene. That is, roaming position information is input into the three-dimensional grid model, so that the three-dimensional grid model output the grid data corresponding to the roaming position information. Among them, grid data can be expressed as Mesh data.

Because in the present application, there are a plurality of position points in the roamable area corresponding to the first type of roaming point locations in the virtual scene of the, and each position point corresponds to one Mesh data, therefore, when it is determined that the roaming position information of the user is located in the boundary area of any first type of roaming point location, the present application will obtain the sphere data corresponding to the first type of roaming point location where the user is currently located, and the grid data of the corresponding position point of the user in the roamable area of the first type of roaming point location.

That is, the target virtual scene data obtained based on the roaming position information of the user in the present application can include not only the sphere data, but also the grid data corresponding to the roaming position information.

S204, if the roaming position information is located at the second type of roaming point location, the obtained target virtual scene data includes grid data corresponding to the roaming position information.

Note that the second type of roaming point location is a point location other than the default point, and each second type of roaming point location has no corresponding virtual scene data, but each position point in the roamable area corresponding to each second type of roaming point location has corresponding virtual scene data. Moreover, the virtual scene data corresponding to each position point in the roamable area corresponding to each second type of roaming point location is specifically grid data. Therefore, when it is determined that the user's roaming position information is located at a certain second type of roaming point location, the obtained target virtual scene data is the grid data corresponding to the roaming position information.

S205, obtaining a target roaming image based on the roaming position information, the roaming view information and the target virtual scene data.

After having obtained the target virtual scene data based on the roaming position information, the present application can, based on the roaming position information and the roaming view information, determine an image corresponding to the target virtual scene data so as to render the image, and display the rendered target roaming image.

In some alternative embodiments, considering that the roaming position information may be located at a certain first type of roaming point location or a certain second type of roaming point location, the present application obtains the target roaming image based on the roaming position information, roaming view information and target virtual scene data, which may include the following situations:

In a first situation, when the target virtual scene data includes sphere data corresponding to the current first type of roaming point location, a panoramic image corresponding to the sphere data is determined based on the roaming position information and the roaming view information, and the panoramic image is rendered to obtain a target roaming image.

In a second situation, when the target virtual scene data includes sphere data corresponding to the current first type of roaming point location and grid data corresponding to the roaming position information, a panoramic image corresponding to the sphere data and a target image corresponding to the grid data are determined based on the roaming position information and the roaming view information. Then, the panoramic image corresponding to the sphere data and the target image corresponding to the grid data are mixedly rendered to obtain the target roaming image.

Among them, mixed rendering of the panoramic image corresponding to the sphere data and the target image corresponding to the mesh data can optionally be weighted mixed rendering or other kinds of mixed rendering, and the present application does not impose any restrictions on this.

In a third situation, when the target virtual scene data includes the grid data corresponding to the roaming position information, the target image corresponding to the grid data is determined based on the roaming position information and the roaming view information. Then, the target image is rendered to obtain the target roaming image.

In the present application, the images determined in the above three situations are rendered, specifically, are rendered in a manner of volume rendering.

Moreover, when the panoramic image determined in the above situations corresponds to the multi-sphere data, that is, the panoramic image is a multi-sphere image, the present application may perform the volume rendering of the multi-sphere image by utilizing the following formula:

$${c}_{r} = {\sum }_{i = 1}^{n} {α}_{i} {c}_{i} {\prod }_{j = i + 1}^{n} ( 1 - {α}_{j} )$$

Wherein, cᵣ indicates a RGB color value finally presented on the target roaming image by pixel points on the i-th sphere layer intersecting with the user's observation rays (a plurality of sampling light rays emitted from the user's eyes), and Σ indicates a sum symbol, n indicates n sphere layers corresponding to the user's roaming position information serving as the center point, 1≤n≤N, and n is arranged from far to near according to the distance between each sphere layer and the user's eye, N is an integer greater than 2, and aᵢ indicates opacity of pixel points on the i-th sphere layer intersecting with the user's observation rays, cᵢ indicate color information of pixel points on the i-th sphere layer intersecting with the user's observation rays, j is a sphere layer between the i-th sphere layer and the roaming position information, II is the multiplication symbol, and aⱼ indicates opacity of pixel points on the j-th sphere layer intersecting with the user's observation rays.

In some alternative embodiments, considering that a communication connection is established between the terminal device and the server, the terminal device can send the roaming position information and roaming view information of the user to the server. In turn, the server determines the target virtual scene data based on the roaming position information, and obtains the target roaming image based on the roaming position information, roaming view information and the target virtual scene data. After having obtained the target roaming image, the server can send the target roaming image to the terminal device, so that the terminal device can directly display the target roaming image, thereby avoiding the terminal device from performing image rendering operation and improving the display speed of the roaming image.

When the target roaming image obtained by the server based on the roaming position information, roaming view information and target virtual scene data sent by the terminal device can be optionally a multi-layer sphere image, the server can perform volume rendering on the multi-layer sphere image based on a volume rendering formula designed in the neural radiance field generated for the real scene, specifically referring to the following formula:

$${\sum }_{n = 1}^{N} T ( {t}_{1} \to {t}_{n} ) * ( 1 - exp ( - {σ}_{n} ( {t}_{n +} 1 - {t}_{n} ) ) ) * {c}_{n}$$

Where, n is the serial number of each ray sampling point belonging to the same radiation light at each first type of roaming point location when the ray sampling points are arranged from near to far. tₙ indicates the distance between the n-th ray sampling point and the first type of roaming point location. On can be the bulk density of the n-th ray sampling point, and cₙ can be the RGB color value of the n-th ray sampling point.

Then, the opacity of the n-th ray sampling point can be expressed by (1−exp(−σₙ(tₙ₊₁−tₙ))).

T (t₁→tₙ) can be the transmittance from the first ray sampling point to the n-th ray sampling point when the ray sampling points on the same radiation light at the first type of roaming point location are arranged from near to far.

Where

$$T ( {t}_{1} \to {t}_{n} ) = exp ( {\sum }_{k = 1}^{n - 1} - {σ}_{k} {δ}_{k} ) ,$$

represents the distance between adjacent ray sampling points, that is, tₖ₊₁−tₖ.

Therefore, according to the above formula, for each first type of roaming point location, the color information of a part of ray sampling points at the point location that can affect each layer can be projected on the layer, and the color intensity after projection on the layer can be calculated, to obtain the rendered image on each layer at the first type of roaming point location, so as to form a multi-sphere image reconstructed at the first type of roaming point location.

According to the technical scheme provided by the embodiments of the present application, the roaming position information and the roaming view information of the user in the virtual scene are acquired to obtain the target virtual scene data based on the roaming position information and the roaming view information, and in turn the target roaming image is obtained based on the roaming position information, the roaming view information and the target virtual scene data, so that the user can have a more stereoscopic effect when roaming in the virtual scene, the immersivity of the user roaming in the virtual scene can be improved, and an immersive roaming experience can be achieved.

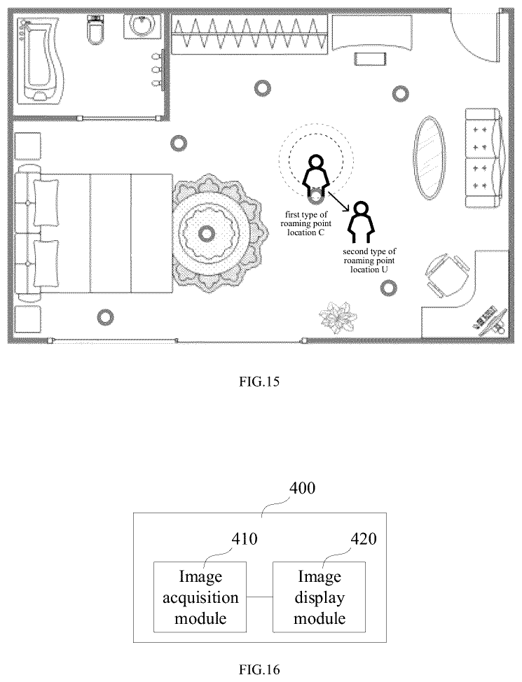

In an alternative implementation of the present application, considering that a first type of roaming point location in the virtual scene includes: the central area and the boundary area, then, when the user's roaming position information is located in the boundary area of any first type of roaming point location, by spatially compressing the user's roaming position information, it can be ensured that the user can move freely within the current first type of roaming point location without exceeding the roamable area corresponding to the first type of roaming point location, thus ensuring that a quality of the displayed roaming image quality is always in the best state, and detect problems, such as the displayed roaming image has poor quality, is distorted or deformed, etc., would not occur due to the user's roaming position information being located in the boundary area of the current first type of roaming point location or about to move out of the boundary area. With reference to FIG. 14, the virtual scene display method provided by the embodiments of the present application will be further explained.

As shown in FIG. 14, the method may include the following steps:

S301, acquiring roaming information of a user in a virtual scene, wherein the roaming information includes roaming position information and roaming view information.

S302, in response to the roaming position information being located in the boundary area of the first type of roaming point location, spatially compressing the roaming position information according to a nonlinear compression mode, and acquiring sphere data corresponding to the current first type of roaming point location and grid data corresponding to the roaming position information, so as to take the sphere data and the grid data as target virtual scene data.

S303: obtaining the target roaming image based on the roaming position information, the roaming view information and the target virtual scene data.

Considering the characteristics of sphere images, when the roamable area is approached or exceeded, the rendering results may be distorted or deformed because the conditions of local approximation are no longer satisfied. Therefore, in the present application, when it is determined that the roaming position information of the user is located in the boundary area of the current first type of roaming point location, the user's roaming position information is nonlinearly compressed, so that the closer the user's moving position is to the boundary position of the roamable area, the more intense the space compression will be, thereby the smaller the actual moving distance of the user will be, therefore, the user can move freely and smoothly in the roamable area of the first type of roaming point location without exceeding the roamable area, and thus a high-fidelity roaming image without distortion or deformation can always be displayed to the user.

In some alternative embodiments, the nonlinear compression of the roaming position information of the user according to the nonlinear compression mode as mentioned above can be realized by the following formula:

$$contract ( x ) = \{ \begin{matrix}x , ‖ x ‖ \leq a * {r}_{i} \\ ( {r}_{i} - \frac{1}{‖ x ‖} ) ( \frac{x}{‖ x ‖} )\end{matrix}$$

Where, contract (x) is position information obtained by spatial compression of roaming position information of users, x is the roaming position information of users, and ∥ ∥ is the modulo symbol is obtained, a is a spatial compression parameter and this parameter is an adjustable parameter, rᵢ is the radius of the roamable area of the current first type of roaming point location.

For example, assuming that the user is located in the central area of the first type of roaming point location B before moving, when the user moves from the central area of the first type of roaming point location B to the boundary area of the first type of roaming point location B, the roaming position information of the user in the boundary area of the first type of roaming point location B is spatially compressed by using the above pose compression formula, so that the user will not move out of the roamable area of the first type of roaming point location B, thus ensuring that the user can always see high-fidelity roaming images at the first type of roaming point location B.

In some alternative embodiments, the present application also includes: in response to selection operation of any new roaming point location, controlling the user to jump from the current roaming point location to the new roaming point location, and switching the roaming image corresponding to the current roaming point location to the roaming image corresponding to the new roaming point location; wherein, the current roaming point location is the first type of roaming point location or the second type of roaming point location, and the new roaming point location is another first type of roaming point location or another second type of roaming point location other than the current roaming point location.

For example, as shown in FIG. 15, assuming that the user is currently located in the roamable area of a first type of roaming point location C, the user can click a second type of roaming point location U in the virtual scene to make the user jump from the first type of roaming point location C to the second type of roaming point location U, and concurrently the roaming image corresponding to the first type of roaming point location C is switched to the roaming image corresponding to the second type of roaming point location U.

That is, the user can select any roaming point location from the virtual scene other than the current roaming point location for jumping to, so that when the user jumps from the current roaming point location to a new roaming point location, the user can watch the roaming image corresponding to the new roaming point location after jumping.

Among them, the user to select any roaming point location other than the current roaming point location can be realized in a variety of manners such as rocker, click or eye tracking, etc., the details can refer to the user's mobile operation in the virtual scene in the previous embodiments, and will not be repeated here.

According to the technical scheme provided by the embodiments of the present application, the roaming position information and the roaming view information of the user in the virtual scene are acquired to obtain the target virtual scene data based on the roaming position information and the roaming view information, and in turn the target roaming image is obtained based on the roaming position information, the roaming view information and the target virtual scene data, so that the user can have a more stereoscopic effect when roaming in the virtual scene, the immersivity of the user roaming in the virtual scene can be improved, and an immersive roaming experience can be achieved. In addition, when it is detected that the roaming position of the user after moving is located in the boundary area of the default roaming point location, the roaming position of the user after moving is spatially compressed, so that the user will not move out of the roamable area of the first type of roaming point location, thus ensuring that the user can always see high-fidelity roaming images at the roaming point location.

Next, with reference to FIG. 16, a virtual scene display apparatus provided by an embodiment of the present application will be described. FIG. 16 is a schematic block diagram of the virtual scene display apparatus provided by an embodiment of the present application.

As shown in FIG. 16, the virtual scene display apparatus 400 includes an information acquisition module 410 and an image display module 420.

Among them, the information acquisition module 410 is configured to acquire roaming information of a user in a virtual scene, wherein the roaming information comprises roaming position information and roaming view information;

The image display module 420 is configured to obtain a target roaming image based on the roaming position information, the roaming view information and target virtual scene data, wherein the target virtual scene data is determined based on the roaming position information and the virtual scene data, and the virtual scene data comprises a neural radiance field generated at least partially based on a real scene.

In one or more alternative implementations of the embodiment of the present application, the virtual scene includes at least one first type of roaming point location, the roaming position information is located at the first type of roaming point location, and the target virtual scene data includes sphere data corresponding to the current first type of roaming point location, and the sphere data is generated according to the neural radiance field.

In one or more alternative implementations of the embodiment of the present application, the sphere data is multi-sphere data.

In one or more alternative implementations of the embodiment of the present application, the target virtual scene data further includes grid data corresponding to the roaming position information.

In one or more alternative implementations of the embodiment of the present application, the first type of roaming point location includes a central area and a boundary area, and in response to the roaming position information being located in the central area of the first type of roaming point location, the target virtual scene data includes sphere data corresponding to the current first type of roaming point location; in response to the roaming position information being located in the boundary area of the first type of roaming point location, the target virtual scene data includes sphere data corresponding to the current first type of roaming point location and grid data corresponding to the roaming position information.

In one or more alternative implementations of the embodiment of the present application, the apparatus 400 further includes:
a compression module, configured to, in response to the roaming position information being located in the boundary area of the first type of roaming point location, spatially compress the roaming position information in a nonlinear compression mode.

In one or more alternative implementations of the embodiment of the present application, the virtual scene further comprises at least one second type of roaming point location, the roaming position information is located at the second type of roaming point location, and the target virtual scene data includes grid data corresponding to the roaming position information.

One or more alternative implementations of the embodiment of the present application, the image display module 420, is specifically configured to:
in response to the target virtual scene data including sphere data corresponding to the current first type of roaming point location and grid data corresponding to the roaming position information, mixedly render the sphere data corresponding to the current first type of roaming point location and the grid data corresponding to the roaming position information, to obtain the target roaming image.

In one or more alternative implementations of the embodiment of the present application, the apparatus 400 further includes:
an image switching module, configured to, in response to a selection operation of any new roaming point location, control the user to jump from the current roaming point location to the new roaming point location, and switch the roaming image corresponding to the current roaming point location to the roaming image corresponding to the new roaming point location;
wherein, the current roaming point location is a first type of roaming point location or a second type of roaming point location, and the new roaming point location is another first type of roaming point locations or another second type of roaming point locations other than the current roaming point location.

It should be understood that the apparatus embodiment and the aforementioned method embodiment can correspond to each other, and similar descriptions can refer to the method embodiment. In order to avoid repetition, such description will not be repeated here. Specifically, the apparatus 400 shown in FIG. 16 can execute embodiments of virtual scene display method according to the present application, for example, the method embodiment corresponding to FIG. 10, and the aforementioned and other operations and/or functions of each module in the apparatus 400 are respectively to realize the corresponding processes in virtual scene display method according to the present application, for example, each method in FIG. 10, and are not repeated here for brevity.

The above-mentioned method and/or apparatus embodiments of the embodiment of the present application are described from the perspective of functional modules in conjunction with the attached drawings. It should be understood that the functional modules can be realized by hardware, by instructions in software, and by a combination of hardware and software modules. Specifically, each step of the method embodiments in the embodiments of the present application can be completed by an integrated logic circuit of hardware and/or an instruction in the form of software in the processor, and the steps of the method disclosed in combination with the embodiment of the present application can be directly embodied as being completed by the hardware decoding processor or completed by the combination of hardware and software modules in the decoding processor. Alternatively, the software module can be located in a mature storage medium in the art such as random-access memory, flash memory, read-only memory, programmable read-only memory, electrically erasable programmable memory, registers, etc. The storage medium is located in the memory, and the processor reads the information in the memory and completes the steps in the above method embodiments in combination with its hardware.

FIG. 8 is a schematic block diagram of an electronic device provided by an embodiment of the present application.

As shown in FIG. 8, the electronic device 800 may include:

A memory 810 and a processor 820, wherein the memory 810 is used for storing a computer program and transmitting the program codes to the processor 820. In other words, the processor 820 can call and run a computer program from the memory 810 to realize the method in the embodiments of the present application.

For example, the processor 820 can be used to execute the above method embodiments according to instructions in the computer program.

In some embodiments of the present application, the processor 820 may include, but not limited to:

General processor, Digital Signal Processor (DSP), application specific integrated circuit (ASIC), Field Programmable Gate Array (FPGA) or other programmable logic devices, discrete gate or transistor logic devices, discrete hardware components, and so on.

In some embodiments of the present application, the memory 810 includes, but is not limited to:

Volatile memory and/or nonvolatile memory. Among them, the nonvolatile memory can be Read-Only Memory (ROM), programmable read-only memory (PROM), erasable programmable read-only memory (EPROM), electrically erasable programmable read-only memory (EEPROM) or flash memory. The volatile memory may be a Random Access Memory (RAM), which is used as an external cache. By way of illustration, without limitation, many forms of RAM are available, such as static random-access memory (SRAM), dynamic random-access memory (DRAM), synchronous dynamic random access memory (Synchronous DRAM, SDRAM), Double Data Rate SDRAM synchronous dynamic random access memory (DDR SDRAM), enhanced synchronous dynamic random access memory (ESDRAM), synchronous link dynamic random access memory (SLDRAM) and direct memory bus random access memory (DR RAM).

In some embodiments of the present application, the computer program may be divided into one or more modules, which are stored in the memory 810 and executed by the processor 820 to complete the method provided by the present application. The one or more modules can be a series of computer program instruction segments that can accomplish specific functions, and the instruction segments are used to describe the execution process of the computer program in the electronic device 800.

As shown in FIG. 8, the electronic device may further include:

A transceiver 830 that can be connected to the processor 820 or the memory 810.

The processor 820 can control the transceiver 830 to communicate with other devices, specifically, it can send information or data to other devices, or receive information or data from other devices. The transceiver 830 may include a transmitter and a receiver. The transceiver 830 may further include antennas, and the number of antennas may be one or more.

It should be understood that all components in the electronic device 800 are connected by a bus system, wherein the bus system includes a power bus, a control bus and a status signal bus, in addition to a data bus.

The present application also provides a computer storage medium, on which a computer program is stored, which, when executed by a computer, enables the computer to perform the method of the above method embodiment.

Embodiments of the present application also provide a computer program product containing computer programs/instructions, which, when executed by a computer, cause the computer to perform the methods of the above method embodiments.

When implemented in software, it can be fully or partially implemented in the form of a computer program product. The computer program product includes one or more computer instructions. When the computer program instructions are loaded and executed on a computer, the flow or function according to the embodiments of the present application can be generated as a whole or in part. The computer can be a general-purpose computer, a special-purpose computer, a computer network, or other programmable devices. The computer instructions can be stored in a computer-readable storage medium or transmitted from one computer-readable storage medium to another. For example, the computer instructions can be transmitted from one website, computer, server or data center to another website, computer or server by wired (such as coaxial cable, optical fiber, digital subscriber line (DSL)) or wireless (such as infrared, wireless, microwave, etc.). The computer-readable storage medium can be any available medium that a computer can access or a data storage device such as a server or a data center that contains one or more available media integration. The usable medium may be a magnetic medium (e.g., floppy disk, hard disk, magnetic tape), an optical medium (e.g., digital video disc (DVD)), or a semiconductor medium (e.g., solid state disk (SSD)) and the like.

One of ordinary skill in the art can realize that the modules and algorithm steps described in connection with the embodiments disclosed herein can be implemented in electronic hardware, or a combination of computer software and electronic hardware. Whether these functions are implemented in hardware or software depends on the specific application and design constraints of the technical scheme. Skilled people can use different methods to realize the described functions for each specific application, but this implementation should not be considered beyond the scope of the present application.

In several embodiments provided by the present application, it should be understood that the disclosed systems, devices and methods can be realized in other ways. For example, the device embodiment described above is only schematic. For example, the division of the module is only a logical function division. In actual implementation, there may be other division methods, such as multiple modules or components can be combined or integrated into another system, or some features can be ignored or not implemented. On the other hand, the mutual coupling or direct coupling or communication connection shown or discussed can be indirect coupling or communication connection through some interfaces, devices or modules, which can be electrical, mechanical or other forms.

The modules described as separate components may or may not be physically separated, and the components displayed as modules may or may not be physical modules, that is, they may be located in one place or distributed to multiple network elements. Some or all of the modules can be selected according to actual needs to achieve the purpose of this embodiment. For example, each functional module in each embodiment of the present application can be integrated into one processing module, or each module can exist physically alone, or two or more modules can be integrated into one module.

In the embodiment of the present application, the term “module” or “unit” refers to a computer program or a part of a computer program with a predetermined function, and works with other related parts to achieve a predetermined goal, and can be realized in whole or in part by using software, hardware (such as a processing circuit or a memory) or a combination thereof. Similarly, a processor (or multiple processors or memories) can be used to implement one or more modules or units. Furthermore, each module or unit can be a part of an overall module or unit that contains the functions of the module or unit.

The above is only specific implementations of the present application, but the protection scope of the present application is not limited to these. Any person familiar with this technical field can easily conceive of changes or alternatives within the technical scope disclosed in the present application, which should be included in the protection scope of the present application. Therefore, the protection scope of the present application should be based on the protection scopes of the claims.

What is claimed is:

1. A three-dimensional scene reconstruction method, comprising:
constructing a neural radiance field for a three-dimensional scene based on a multi-view image sequence in the three-dimensional scene;
for each given point location center, determining ray sampling points at the point location center and color information of the ray sampling points based on the neural radiance field;
performing multi-layer rendering on the color information of the ray sampling points to obtain a multi-sphere image reconstructed for the three-dimensional scene at the point location center.

2. The method of claim 1, wherein the performing multi-layer rendering on the color information of the ray sampling points to obtain a multi-sphere image reconstructed for the three-dimensional scene at the point location center, comprises:
performing depth rendering on ray sampling points of each radiation ray at the point location center, to obtain a minimum radiation depth and maximum radiation depth at the point location center;
determining the number of layers and the depth information of each layer at the point location center based on the minimum radiation depth, the maximum radiation depth and a preset depth relationship between adjacent layers;
based on the depth information of each layer and the depth information of the ray sampling points, performing multi-layer rendering on the color information of the ray sampling points to obtain a multi-sphere image reconstructed for the three-dimensional scene at the point location center.

3. The method of claim 2, wherein the determining the number of layers and the depth information of each layer at the point location center based on the minimum radiation depth, the maximum radiation depth and a preset depth relationship between adjacent layers, comprises:
taking the minimum radiation depth as the depth information of a first layer and take the first layer as the current layer;
performing a multi-layer depth determination step: determining the depth information of a next layer based on the depth information of the current layer and a preset depth relationship between adjacent layers;
taking the next layer as the new current layer, and continuing to perform the multi-layer depth determination step until the depth information of the latest layer is greater than or equal to the maximum radiation depth, so as to obtain the number of layers and the depth information of each layer at the point location center.

4. The method of claim 2, wherein based on the depth information of each layer and the depth information of the ray sampling points, performing multi-layer rendering on the color information of the ray sampling points to obtain a multi-sphere image reconstructed for the three-dimensional scene at the point location center, comprises:
based on the depth information of each layer and the depth information of ray sampling points, determining associated ray sampling points of each layer;
performing volume rendering on the color information of the associated ray sampling points of each layer, to obtain the multi-sphere image reconstructed for the three-dimensional scene at the point location center.

5. The method of claim 2, wherein the depth relationship between adjacent layers satisfies that in the point location, the maximum pixel parallax of an observable line of sight for any pixel point of the previous layer in the adjacent layer, when falling on the subsequent layer in the adjacent layer, is less than or equal to the unit pixel.

6. The method of claim 5, wherein an initial radius of the point location is a preset expected roaming depth, and if the number of layers at the point location center is greater than a preset upper limit of layers, the method further comprises:
re-determining the number of layers and the depth information of each layer at the point location center based on the minimum radiation depth, the maximum radiation depth and the preset depth relationship between adjacent layers at the point location center by reducing the radius of the point location in the depth relationship between adjacent layers, so that the re-determined number of layers is less than or equal to the preset upper limit of layers.

7. The method of claim 1, wherein the method further comprises:
according to the neural radiance field, determining a multi-view image sample sequence in the point location in a plurality of preset sampling poses,
performing volume rendering on color information of intersection points between a projected light ray in each sampling pose and the multi-sphere image reconstructed at the point location center, so as to obtain a multi-view rendered image sequence in the point location.
based on the difference between the multi-view image sample sequence and the multi-view rendered image sequence, optimizing the multi-sphere image reconstructed at the point location center.

8. The method of claim 1, wherein, for each given point location center, the determining ray sampling points at the point location center and color information of the ray sampling points based on the neural radiance field, comprises:
for each given point location center, determining the radiation light ray and the ray sampling points on the radiation light ray at the point location center according to the neural radiance field;
determining the color information of the ray sampling point according to the neural radiance field.

9. The method of claim 1, wherein, the method further comprises:
acquiring information about roaming pose of the user, wherein the information about roaming pose includes the roaming position and roaming posture;
if the roaming position is within the point location, displaying a corresponding roaming image according to the information about roaming pose and the multi-sphere image reconstructed at the point location center.

10. The method of claim 1, wherein,
based on roaming position information of a user in a virtual scene approximated by the multi-sphere image and target virtual scene data, a target roaming image is obtained for displaying, wherein the target virtual scene data is determined based on the roaming position information and virtual scene data, and the virtual scene data comprises the constructed neural radiance field.

11. The method of claim 10, wherein, the virtual scene includes at least one first type of roaming point location, the roaming position information is located at the first type of roaming point location, and the target virtual scene data includes the multi-sphere data corresponding to the current first type of roaming point location.

12. The method of claim 10, wherein, the target virtual scene data further comprises grid data corresponding to the roaming position information.

13. The method of claim 12, wherein, the first type of roaming point location comprises a central area and a boundary area, and in response to the roaming position information being located in the central area of the first type of roaming point location, the target virtual scene data includes multi-sphere data corresponding to the current first type of roaming point location; in response to the roaming position information being located in the boundary area of the first type of roaming point location, the target virtual scene data includes multi-sphere data corresponding to the current first type of roaming point location and grid data corresponding to the roaming position information.

14. The method of claim 13, wherein, in response to the roaming position information being located in the boundary area of the first type of roaming point location, the roaming position information is spatially compressed in a nonlinear compression mode.

15. The method of claim 10, wherein, the virtual scene further comprises at least one second type of roaming point location, the roaming position information is located at the second type of roaming point location, and the target virtual scene data includes grid data corresponding to the roaming position information.

16. The method of claim 13, wherein, in response to the target virtual scene data including sphere data corresponding to the current first type of roaming point location and grid data corresponding to the roaming position information, the multi-sphere data corresponding to the current first type of roaming point location and the grid data corresponding to the roaming position information is mixedly rendered, to obtain the target roaming image.

17. The method of claim 10, wherein, in response to a selection operation of any new roaming point location, the user is controlled to jump from the current roaming point location to the new roaming point location, and the roaming image corresponding to the current roaming point location is switched to the roaming image corresponding to the new roaming point location;
wherein, the current roaming point location is a first type of roaming point location or a second type of roaming point location, and the new roaming point location is another first type of roaming point locations or another second type of roaming point locations other than the current roaming point location.

18. An electronic device, comprising:
a processor; and
a memory for storing executable instructions of the processor;
wherein the executable instructions, when executed by the processor, cause the processor to implement:
constructing a neural radiance field for a three-dimensional scene based on a multi-view image sequence in the three-dimensional scene;
for each given point location center, determining ray sampling points at the point location center and color information of the ray sampling points based on the neural radiance field;
performing multi-layer rendering on the color information of the ray sampling points to obtain a multi-sphere image reconstructed for the three-dimensional scene at the point location center.

19. A non-transitory computer-readable storage medium on which a computer program is stored, wherein the computer program, when executed by a processor, causes the processor to implement:
constructing a neural radiance field for a three-dimensional scene based on a multi-view image sequence in the three-dimensional scene;
for each given point location center, determining ray sampling points at the point location center and color information of the ray sampling points based on the neural radiance field;
performing multi-layer rendering on the color information of the ray sampling points to obtain a multi-sphere image reconstructed for the three-dimensional scene at the point location center.
